(19) United States
(12) Patent Application Publication
(10) Pub. No.: US 2026/0300739 A1
(43) Pub. Date: Oct. 1, 2026

(54) Automated LLM-Based Estimation of Intent of Users Accessing Files and Organizational Resources

(71) Applicant: VARONIS SYSTEMS, INC., New York, NY (US)

(72) Inventors: Amir Belgi, Ra’anana (IL); Ron Sneh, Apex, NC (US); Amit Osi, Tel Aviv (IL); Lior Chen, Tel Mond (IL); John Eugene Neystadt, Kfar Saba (IL)

(21) Appl. No.: 19/096,774

(22) Filed: Apr. 1, 2025

(51) Int. Cl. G06N 3/0895

(52) U.S. Cl. CPC G06N 3/0895

(57) ABSTRACT

A computerized method includes: (a) receiving a user-provided query directed to an Artificial Intelligence (AI) based assistant tool, that is configured to answer queries based on information from organizational databases of an organization; (b) feeding the user-provided query into a Machine Learning (ML) classification model, to classify the user-provided query as one of: (b1) a possibly-malicious query, or (b2) a non-malicious query; (c1) if the ML classification model classified the user-provided query as non-malicious, then: processing the user-provided query by the AI-based assistant tool; (c2) conversely, if the ML classification model classified the user-provided query as possibly-malicious, then: feeding the user-provided query to a Large Language Model (LLM) based Intent Detector that performs LLM analysis of the user-provided query and of organizational context, that provides LLM-generated output indicating whether the user-provided query is indeed malicious and violates organizational policies.

### FIELD

Some embodiments are related to the field of computerized systems.

### BACKGROUND

A large corporation, organization, or other entity may have thousands of team-members who utilize computing devices for various purposes; for example, to send and receive electronic mail, to engage in video calls, to browse the Internet, to compose documents, to access data repositories, or the like.

The organization may accumulate and store a large volume of documents and data-items, such as textual files, spreadsheets, presentations, multimedia files, raw data, or the like. Users in the organization may be able access such documents and data-items through their computing devices.

### SUMMARY

Some embodiments may provide systems and methods for automatically estimating or predicting or determining the intent of a user who is accessing (or, is requesting access to) a file or document or folder or other organizational resource. Some embodiments may utilize a multiple-tier analysis that uses Machine Learning (ML)/Deep Learning (DL) model(s) as a first tier of analysis, and then uses a Large Language Model (LLM) or a Large Multi-Modalities Model (LMMM) as a second tier of analysis, in order to efficiently determine or estimate such user intent. Based on the automatically-determined user intent, the system may trigger one or more actions or operations; for example, blocking or un-authorizing or non-allowing access to a particular user-requested resource, authorizing or allowing or providing access to a particular user-requested resource, generating or sending an alert notification or alert message to one or more recipients, or other operations.

In some embodiments, a computerized method includes: (a) receiving a user-provided query directed to an Artificial Intelligence (AI) based assistant tool, that is configured to answer queries based on information from organizational databases of an organization; (b) feeding the user-provided query into a Machine Learning (ML) classification model, to classify the user-provided query as one of: (b1) a possibly-malicious query, or (b2) a non-malicious query; (c1) if the ML classification model classified the user-provided query as non-malicious, then: processing the user-provided query by the AI-based assistant tool; (c2) conversely, if the ML classification model classified the user-provided query as possibly-malicious, then: feeding the user-provided query to a Large Language Model (LLM) based Intent Detector that performs LLM analysis of the user-provided query and of organizational context, that provides LLM-generated output indicating whether the user-provided query is indeed malicious and violates organizational policies.

Some embodiments may provide other and/or additional benefits and/or advantages.

### BRIEF DESCRIPTION OF THE DRAWINGS

FIG. 1 is a schematic illustration of a system, in accordance with some demonstrative embodiments.

FIG. 2 is a schematic block-diagram illustration of an implementation of a system, in accordance with some demonstrative embodiments

### DETAILED DESCRIPTION OF SOME DEMONSTRATIVE EMBODIMENTS

The Applicant has realized that some organizations allow or enable users to interact with organizational resources (e.g., files, folders, databases, documents, data-items) using an Artificial Intelligence (AI) based assistant or tool. For example, realized the Applicant, users may prompt Chat-GPT or Microsoft Copilot or other Large Language Model (LLM) or Large Multi-Modalities Model (LMMM), to fetch or obtain particular information or document data-item from organization resources.

The Applicant has further realized that in some situations, a user may interact with such AI-based tool or AI-based assistant in a manner that contradicts or violates organizational access policies or organizational file-access policies, or in a manner that poses or that may pose a risk to the organization, or in a manner that may cause a security breach or data leakage or unauthorized access to resources.

For example, realized the Applicant, a junior assistant in the organization may provide to an organizational LLM a prompt such as, “Please provide a list of the ten employees in our organization that have the highest salary, with their names and salary”; or may input to the organizational LLM a question such as, “How much money did the organization earn last month from selling Product Tiger?”; or other prompts or questions that may inquire about, or that may attempt to obtain, sensitive data, confidential data, private/personal data, financial data of the organization, Human Resources (HR) data of the organization, passwords or API keys, or other privileged information.

The Applicant has also realized that in some situations, such query or prompt may be legitimate and authorized; for example, the CFO or the HR Manager of the organization may be allowed to inquire about the top-earning employees, and the CTO of the organization may be allowed to inquire about passwords and API keys; whereas an administrative assistant or a junior developer or a salesperson may typically not be allowed to obtain such information.

The Applicant has realized that it may be beneficial to perform an automated process that estimates or predicts or determines the intent of the user who enters such prompt or question; or that estimates or predicts or determines whether such prompt or question is more-likely to be associate with an unauthorized/illegitimate attempt to access information that this particular user is not authorized or not expected to access; or that estimates or predicts or determines whether such prompt or question reflects Malicious Intent.

In some implementations, a system may be configured to train and then utilize a ML/DL model, in an attempt to detect a malicious intent of a user based on a user-provide prompt or question. However, realized the Applicant, such implementations may be complex to build or construct or train or deploy, and may typically require a time-consuming and effort-consuming process that involves one or more human data scientists. Furthermore, realized the Applicant, the resulting ML/DL model might be able to perform initial topic classification (e.g., “the prompt is related to Financial data”, or “the question is related to HR data”, or “the prompt is related to Passwords”), but this does not suffice and does not assist in discovering the Intent of the user (e.g., what exactly is this particular user trying to achieve with this particular prompt/question). Additionally, realized the Applicant, such ML/DL approach does not efficiently provide a flexible mechanism that would allow users (e.g., managers in the organization) to define Intent Policies or user-defined intent-related conditions or rules.

In other implementations, a system may be configured to utilize an LLM in order to estimate the user intent behind each and every user prompt or user question. However, realized the Applicant, such implementations may suffer from various problems or inefficiencies, such as: (a) LLM analysis of each user query or user prompt is typically slow, and would significantly slow-down the process in which users obtain answers to their questions; (b) the LLM-based analysis is costly in terms of computing resources and/or monetary costs, and even the most cost-effective LLM-based system may incur significant monetary costs and/or computing costs once if it is invoked thousands of times per minute or per hour (e.g., in a large organization having thousands or tens-of-thousands of team-members); (c) the LLM-based analysis becomes more cumbersome and/or more costly and/or slower as managers in the organization define or add or modify intent detection policies or intent detection rules or intent-related rules; (d) the LLM-based analysis of each and every user query or user prompt would typically cause latency and performance delays that are unacceptable to most users, or that reduce the productivity of team-members as they wait longer to receive responses to their queries or prompts; (e) in some conventional implementations, the human user who defines the organizational policy is often not an expert at prompt engineering, and/or may spend time and effort in attempts to author a comprehensive prompt, and/or may often author a prompt covers only some and not all relevant situations, and/or may have difficulties to perform tuning of the manual prompt due to missed detections.

In accordance with some embodiments, a two-tier or dual-tier or multiple-tier system is configured, in order to perform a first tier of ML/DL analysis or classification of all user prompts/all user queries, that is then selectively followed by a second tier of LLM-based analysis that is invoked only with regard to particular prompts/queries that were indicated by the ML/DL tier as candidates for malicious intent or as candidates for further LLM-based investigation.

Some embodiments may be implemented in a variety of ways, in order to achieve the functionalities described herein. As non-limiting examples, some embodiments may be implemented as an integral or internal module of an AI-Based Assistant Tool; or as an extension or plug-in or add-on to an existing AI-Based Assistant Tool; or as a brand-new AI-Based Assistant Tool that contains therein the features or the functionalities described herein; or as a Pre-Assistant unit that intercepts user-queries before they reach the AI-Based Assistant Tool and evaluates/filters/blocks/quarantines/delays non-permissible user queries; as a Post-Assistant unit that intercepts user-queries after they reached the AI-Based Assistant Tool and evaluates/filters/blocks/quarantines/delays responses to non-permissible user queries; as a unit or module that runs in parallel to the AI-Based Assistant Tool and evaluates user queries in order to flag non-permissible queries and/or in order to generate and send alert notification to supervisor(s) regardless of whether or not the AI-Based Assistant Tool receives the user query and/or responds to the user query; as part of an interface or a native application or a mobile application or “app”, or as part of a web browser, or as an extension/add-on/plug-in to a web browser or to an AI-Based Assistant Tool application or “app”, that is configured to filter-out or quarantine or delay or block or report user queries that are non-permissible; or as a unit or module in the pipeline of the AI-Based Assistant Tool and/or of the various Organizational Database(s) that the AI-Based Assistant Tool is authorized to access; as a cloud-based or cloud-computing based service or solution or implementation, that inspects or evaluates user queries to the AI-Based Assistant Tool, in real time or substantially in real time or retroactively (e.g., in order to flag and report violating user queries after-the-fact and not necessarily to block them in real time); and/or as other suitable module or unit of an organizational system.

At an overview, the system of some embodiments begins with Data Collection, in order to construct an Organizational Context (OC) database. The following data can be collected or extracted regularly from organizational resources: Data from Identity providers and CRM/ERP/systems; the system scans any directories and CRM systems, such as Active Directory, Azure Active Directory, Okta, Salesforce, Hubspot, Microsoft Dynamics 365, or other sources; and extracts all users'information, including the user's Organizational Unit (OU), user title/role, email address, department, and subordinates/peers/managers information. The system further obtains or extracts information describing groups/teams/peer-groups in the organizations, and the members of each such group or team or peer-group. The system constructs the organization structure tree with the information collected as describe above and/or herein, which may further include: Domain Information; Peer groups for users; Events and log entry, such that a record is be kept for all operations (access, read, write, create, delete, copy) in the system; Files, including content and/or file title and/or path and/or file-name and/or meta-data can be embedded in a vectorized database; and/or other data that describes or can provides OC. In other embodiments, as an alternate approach, the system can embed only relevant files/data-items during the access review itself (e.g., in response to a user query/prompt to the AI assistant).

In a demonstrative computerized method, a data collection step is performed in order to construct Organizational Context (OC) that would then be utilized for analysis of user-queries or user-prompts. For example, an OC Collector Unit operates continuously or periodically to collect or augment data from a variety of organizational resources, such as, by scanning any organizational directories, databases of identity providers or identity management systems, Active Director (AD), Azure Active Directory (AAD), Okta database, Salesforce database, Hubspot database, Microsoft Dynamics 365, data from Customer Relationship Management (CRM) systems, data from Supply Chain Management (SCM) systems, data from Enterprise Resource Planning (ERP) systems, data from HR directory/Team-Members directory, data from Organizational Charts or tree-structures or hierarchical structures, or the like. The extracted data is stored in an OC Database, optionally as vectorized data and/or as embeddings. The extracted and stored OC data may include full names of users (e.g., “Adam Smith”), as well as corresponding usernames or handles (e.g., “ASmith”), organizational titles and roles (e.g., “CFO” or “Junior Developer”), email address, organizational department (e.g., “Legal” or “Marketing”), Organization Unit (OU) or organizational group/team (e.g., “Tiger Team” or “Product Gamma Unit”), data about subordinates and/or peers and/or direct supervisors and/or indirect supervisors of each team-member; data describing or indicating teams or groups in the organization, as well as members and/or leaders of each such group or team; Domain Information; Peer groups for users; data about, or data indicating, events (e.g., a record or a log-entry is stored for every event that occurs in the organization system; such as, User Adam accessed Folder-1, User Becky created File-2, User Carl modified File-3, User David deleted Folder-4, User Eve copied File-5); data and meta-data and file-names and paths of each file or document or data-item can further be collected or extracted, and can be stored in a vectorized database and/or as embeddings; content of files or documents or data-items, or at least internal headings or chapter headings from them, can be extracted and similarly stored in a vectorized database and/or as embeddings; and/or other suitable data that can be collected or extracted, with regard to the organization's team-members and the organizational resources.

In some embodiments, the OC database is updated or augmented or incremented continuously, or periodically (e.g., every hour, every day, every week). In other embodiments, optionally, data from thousands or millions of files/documents is not continuously extracted and collected and stored in the OC database; but rather, only once an actual user-query or user-prompt is about to be provide to the second-tier LLM-based analysis, the OC data is firstly extracted from the relevant organizational files/folders/documents/data-items and is made accessible to the LLM in the second-tier analysis.

The system proceeds to perform a multi-phase approach using both ML classification and selective LLM-based analysis. For example, given a new intent policy (e.g., detecting users requesting payroll information), the system can be configured to perform the following steps: (a) Gather the relevant Organizational Context (OC) information; given the prompt, the system generates search queries on the OC that was collected as described above. For example, given the prompt “Only people working on project X may ask the AI assistant about Project x”, the system can check via data access patterns who usually accesses project X resources, their roles, their peers, finding related email messages, and finding other relevant data-items. (b) Trigger the LLM to create synthetic data from two labels: (b1) Prompts within the intent policy; (b2) Prompts that are not within the intent policy (e.g., “negative label” or “exclusion label”). (c) The system extends this data set using RAG and/or other augmentation techniques, optionally using coding (e.g., remove or switch or add a random character to simulate user error) and/or using LLMs (e.g., trigger the LLM to introduce spelling/grammar mistakes). Such generated permutations from the original prompt/query may include, for example: introduce Typographical and Phrasing Variations; Simulate Multilingual and language-Switching Inputs, such as “Prepare the presentation for mañana”; Simulate Multi-Turn Conversations; add or use Time-Sensitive and Context-Aware Prompts; Generate Data for Diverse User Skill Levels; use and/or expand and/or replace Abbreviations and Acronyms; incorporate incomplete or ambiguous inputs; add other types of noise or imperfections into the input to create imperfect permutations. Optionally, the dataset of permutations of the prompt is extended by adding translations into other languages. The system then performs or generates embeddings on the generated dataset (e.g., on the original input with the augmentation permutations and with the alternate natural languages). Optionally, the dataset of permutations is further generated or augmented based on the OC itself as well. The system then runs an ML training process, such as auto-ML using classification algorithms. (d) A detection prompt is then generated based on the generated training dataset, user prompt, and the relevant OC.

When a user prompt/query is received (e.g., the user sends a prompt/query to the organizational AI assistant), the system uses the ML model for initial classification and detection, to determine whether the LLM label is within the relevant category; and if so, and only if so, then the LLM is invoked as the second layer of analysis. This way, the ML model operates efficiently and rapidly to filter-out the vast majority of data in a cost-effective way; and the LLM is invoked to add the improved detection and reduces False Positive errors with its strong natural language understanding capabilities.

Optionally, a user can provide to the system feedback about generated alerts. This ensures that retraining will occur regularly; and user-provided corrections will receive more weight in a re-training process. Optionally, user input and user feedback can be used with RAG for future evaluations of incoming prompts/queries.

If a user adds a new intent policy, then, the system trains a multi-category classification; to ensure that the ML model is trained and run once, and the LLM analysis is run once. This may also account for potential overlap between categories.

At a high-level overview, the system, in some embodiments, begins with an extensive data collection process to construct a dynamic and continuously updated Organizational Context (OC) database. This database serves as the foundational knowledge repository for the system's intent detection and security enforcement mechanisms. The system systematically extracts, retrieves, and processes structured and unstructured data from a variety of organizational resources, ensuring that it captures a comprehensive view of the enterprise's users, teams, roles, and interactions. This includes data retrieved from identity providers, customer relationship management (CRM) systems, enterprise resource planning (ERP) systems, and directory services. The system is designed to interface with widely used enterprise authentication and management platforms, such as Active Directory, Azure Active Directory, Okta, Salesforce, HubSpot, Microsoft Dynamics 365, and other equivalent sources, providing it with real-time access to identity and authorization-related information.

Once connected to these platforms, the system performs a deep extraction of all user-related metadata. This includes the user's assigned Organizational Unit (OU), job title, role-based access control (RBAC) attributes, department affiliations, corporate email addresses, and hierarchical reporting relationships. The reporting structure includes data about a user's subordinates, peers, direct managers, and indirect supervisors, allowing the system to construct an accurate model of authority, decision-making chains, and access permissions. Additionally, the system identifies and classifies users into functional groups, project teams, and peer-group clusters, mapping out collaboration networks and team-based access control configurations. The system continuously monitors changes to these entities, ensuring that organizational restructuring, new hires, and changes in project assignments are reflected in real time.

To further enhance its contextual understanding, the system systematically constructs an enterprise-wide hierarchical model, referred to as the organizational structure tree, which provides an overarching view of the company's departments, divisions, and interrelationships. This hierarchical model is supplemented with additional data sources, including domain-specific knowledge, historical access logs, and enterprise-wide activity records. The system maintains a real-time event log, capturing all user operations such as access attempts, read/write actions, data modifications, file creation, deletion, duplication, and shared access events. These logs are critical in tracking behavioral patterns and anomaly detection. Furthermore, all organizational files, including their content, titles, paths, filenames, metadata, and access control properties, and possibly also sensitivity/confidentiality tags or labels (e.g., already-existing labels or tags or classification flags that indicate whether a file/folder/document/resource is confidential or contains Personally Identifiable Information (PII) or contains sensitive information; such as, pre-generated classification tags or labels generated by a Machine Language (ML) classification model or other automated engine) are indexed and stored within a high-dimensional vectorized database, enabling rapid retrieval and contextual cross-referencing. As an optimization, in alternate implementations, the system selectively embeds only the most relevant files or data items at the time of access review, dynamically determining which resources are contextually relevant based on the incoming user query.

Following data collection and organizational modeling, the system executes a multi-phase detection and classification approach, integrating both machine learning (ML) models and selective large language model (LLM)-based analysis. The system is configured to process and enforce newly defined intent policies, such as detecting unauthorized payroll data requests, monitoring sensitive project information inquiries, or preventing unauthorized access to restricted datasets. When a new intent policy is introduced, the system undertakes a structured, multi-step enforcement process.

In the first step of the enforcement process, the system retrieves the relevant Organizational Context (OC) data to contextualize the policy enforcement. This involves generating structured search queries against the OC database, retrieving entity relationships, access patterns, and historical behavioral data. For example, if an administrator defines an intent policy stating that “Only personnel explicitly assigned to Project X should be permitted to request information regarding Project X”, the system analyzes prior data access logs, authorization patterns, peer-group associations, and historical email communications to determine which users have legitimate access rights and which do not.

In the next step, the system leverages an LLM to generate synthetic training data, constructing a labeled dataset that facilitates high-precision classification. The system generates two primary labels: (1) Prompts that conform to the intent policy, meaning queries that are valid and authorized within the defined rule set; and (2) Prompts that do not conform to the intent policy, often referred to as negative labels or exclusion labels, representing unauthorized or non-compliant inquiries. This classification enables the system to distinguish between benign and potentially malicious or policy-violating user actions.

The system further expands and augments the training dataset using a combination of retrieval-augmented generation (RAG) methodologies and advanced data augmentation techniques. Various transformations are applied to ensure that the detection model remains robust against variations in user input. This includes introducing typographical and phrasing variations, such as misspellings, omitted characters, and alternative syntactic structures, to account for real-world errors in user queries. Additionally, the system generates multilingual translations and cross-language switching variations, where queries are partially or fully translated into multiple languages, ensuring detection accuracy in globalized environments. For example, a user may submit a query in mixed-language form, such as “Prepare the report for mañana”, which combines English with Spanish, requiring the model to correctly interpret the intent.

Further enhancements include simulating multi-turn conversations, where user intent unfolds gradually across multiple sequential interactions rather than being fully expressed in a single query. For example, the LLM unit that is configured to perform generation/augmentation of examples of user queries, is pre-trained and/or fine-tuned to also specialize in the task of breaking a single user-query that is generally non-permissible (e.g., violates an organizational policy or a policy rule) into two (or more) steps of separate queries. For example, the original User Intent Policy may include a non-permissible user query example of “Please tell me the salaries of all Project Managers in the organization”; and the augmentation/permutations LLM may generate, based on this single-step example, a multi-step or multiple-step set-of-queries, such as, “Who are the Project Managers?” and then “What are their salaries?”. The augmentation/permutations LLM may then generate permutations for these multiple-queries; such as, replacing “salaries” with the synonym “compensation” or the synonym “paycheck”, replacing “salaries” with the typographical errors “salaris” or “salarys”, replacing “their” with “there” to simulate a common writing error that is not by itself a typographical error, using/creating/expanding/collapsing contractions or acronyms or abbreviations (e.g., changing “Project Managers” to “PMs”), injecting various other errors or word-ordering errors (e.g., “the project managers, what's their salary?”), and/or generating other permutations to such multiple-step query. It is noted that other components in the system, and particularly the LLM-based Intent Detector unit(s), may similarly be configured/fine-tuned/pre-trained to particularly examine and analyze such multiple steps in a flowing conversation or chat-session of the user with the AI-based Assistant Tool, and such LLM-based Intent Detector unit(s) may similarly specialize in deducing or estimating a malicious/non-benign user intent from a plurality of conversation steps or chat portions that, when examined together by the LLM-based Intent Detector unit, indicate a malicious/non-benign user intent. In some embodiments, the LLM-based Intent Detector unit(s) may be further configured or fine-tuned or pre-trained to take into account, or to combine, non-consecutive steps or turn in the conversation, or multiple chat-portions or multiple user-queries that are not necessarily consecutive to each other; for example, a multi-step conversation that begins with “Who are the Project Managers?”, then continues to “How many PMs are there?”, and then continues to “What are their salaries?”; wherein the first and the third turns (which are non-consecutive to each other) in this conversation are combined by the LLM-based Intent Detector unit to deduce a malicious/non-benign user intent.

The system also generates time-sensitive prompts, incorporating contextual elements such as dates, deadlines, and historical references to ensure that policy violations are detected even when time dependencies are introduced. Additionally, it generates input variations reflecting users of different skill levels, ensuring that both technically proficient users and non-technical employees are accurately classified. The dataset is also expanded to incorporate abbreviations and acronyms, ensuring that commonly used shorthand notations are properly interpreted by the classification model.

Once the augmented dataset is finalized, the system embeds all generated queries into a high-dimensional vector space, ensuring rapid similarity detection during real-time user interactions. The embeddings include the original query, augmented variations, and multilingual translations, creating a broad contextual foundation for accurate intent classification. The system then initiates an automated ML training process, selecting and optimizing classification algorithms using auto-ML techniques to ensure high performance and adaptability.

During live operation, when a user submits a query to the AI assistant, the system employs a tiered detection strategy, wherein a trained ML model performs an initial classification to determine whether the query falls within a relevant policy category. If the ML classifier determines that the query is likely policy-related, the system escalates the input to an LLM for secondary verification. By employing this hierarchical approach, the system efficiently filters the vast majority of non-relevant queries using ML, thereby significantly reducing computational costs and processing latency, while leveraging the LLM's advanced natural language understanding capabilities only in cases where deeper semantic analysis is required. This two-layered approach improves accuracy while preventing excessive false positives.

Additionally, the system incorporates a feedback-driven retraining mechanism, allowing end-users to provide corrective input on generated alerts. If a false positive or false negative detection occurs, users can submit corrections, which are then incorporated into future ML model retraining cycles. This ensures that user-generated corrections receive increased weighting, improving the system's ability to adapt dynamically to evolving organizational policies. Furthermore, all user feedback is integrated into RAG mechanisms, allowing the system to leverage past user interactions to refine future intent detection accuracy.

When a new intent policy is introduced, the system automatically trains a multi-category classification model, ensuring that each query is classified against multiple overlapping policies without requiring redundant ML executions. This optimization allows the ML classifier to execute only once per query, and ensures that the LLM analysis is performed in a single inference step, preventing unnecessary computational overhead. This approach not only reduces system resource consumption but also accounts for overlapping policies, ensuring that user queries are evaluated holistically against all applicable security rules.

By integrating structured data collection, advanced ML classification, retrieval-augmented generation, and hierarchical LLM-based validation, the system provides an efficient, scalable, and cost-effective framework for automated intent detection in enterprise environments. The system is designed to dynamically adapt to evolving security policies, ensuring continuous enforcement of compliance rules, while minimizing operational costs and administrative burdens.

Some embodiments thus provide a solution for automated intent detection in enterprise AI interactions. It is structured around a multi-phase approach that integrates data collection, ML classification, and LLM processing to ensure precise, context-aware detection of user actions while maintaining organizational security. The system continuously retrieves, processes, and analyzes data from multiple organizational sources to construct a comprehensive contextual framework. This data-driven approach allows for a dynamic and scalable mechanism that adapts to evolving security policies and operational needs.

An important step in the method is the continuous and systematic collection of data from identity providers, customer relationship management (CRM) platforms, and enterprise directory services. The system is designed to interface with and extract data from widely used authentication and directory management platforms, including but not limited to Active Directory, Azure Active Directory, Okta, Salesforce, HubSpot, and Microsoft Dynamics 365. This integration allows for the automated retrieval of structured and unstructured identity-related information, ensuring that all relevant organizational entities and user attributes are incorporated into the security model. The collected data encompasses key user details, such as the organizational unit (OU) to which each employee belongs, the specific job title assigned to them, their registered corporate email address, the department under which they operate, and hierarchical reporting relationships, including direct and indirect managerial assignments.

Beyond individual user attributes, the system further compiles information about group memberships, detailing predefined access groups and their respective members, thus establishing a structured representation of enterprise-wide role-based access control. By processing and analyzing these group memberships, the system dynamically builds a comprehensive organization structure tree, which maps interdepartmental relationships, hierarchies, and team collaborations. This hierarchical model serves as a reference for determining data access patterns, ensuring that access controls and intent detection policies remain contextually relevant. Additionally, domain-specific information is collected and continuously updated, providing deeper insights into the organization's operational scope and ensuring that security policies are aligned with real-world business activities.

In order to further refine contextual accuracy, the system identifies and categorizes peer groups within the organization by analyzing shared responsibilities, job functions, and collaboration patterns derived from historical access logs and workflow dependencies. These peer groups are important for assessing expected behaviors and establishing baselines for permissible data access. The system also maintains a real-time, event-driven record of all operational activities within the organization, continuously logging and analyzing actions such as authentication attempts, file modifications, data retrieval requests, and AI-assisted interactions. By embedding file content and metadata within a high-performance vector database, the system enables efficient context-aware retrieval of stored information. In certain implementations, an alternative optimization method is employed, wherein only the most relevant files are embedded at the moment of access review, thereby reducing storage overhead while maintaining high contextual precision.

In order to ensure robust and scalable intent detection, the system employs a multi-phase approach that integrates both classical machine learning techniques and advanced large language models. When a new intent detection policy is defined, such as detecting unauthorized attempts to access payroll information, the system initiates a series of structured processes to enforce and operationalize this policy. The first step in this sequence involves retrieving relevant organizational context by generating search queries that extract corresponding information from previously collected datasets. For instance, if a policy stipulates that only designated team members may inquire about a specific project, the system cross-references user activity logs, access patterns, file interactions, and email correspondence to verify whether the requesting user has a legitimate association with the project in question.

Once the necessary contextual data is gathered, the system proceeds with the creation of synthetic training datasets, which are essential for enhancing the accuracy of the classification model. This synthetic data is constructed through a two-category labeling process, wherein prompts that fall within the scope of the newly defined intent policy are labeled as positive examples, while prompts that do not align with the policy are classified as negative examples. By constructing this dataset, the system ensures that the machine learning model is trained to recognize both compliant and non-compliant interactions. To further enhance the robustness of this dataset, a series of augmentation techniques are applied to introduce variations that reflect real-world user behaviors and potential input inconsistencies.

One such augmentation technique involves the intentional introduction of typographical and phrasing variations, wherein common spelling errors, omitted characters, and alternative sentence structures are simulated to account for variations in user input. Additionally, the system generates multilingual variations by translating prompts into different languages, thereby ensuring that the intent detection model remains effective across diverse linguistic environments. Another augmentation method involves simulating multi-turn conversations, where user inquiries are fragmented across multiple exchanges rather than appearing as a single, self-contained query. By processing conversational interactions, the system improves its ability to recognize intent in complex, context-dependent discussions. Furthermore, the system generates time-sensitive prompts, incorporating temporal references to assess how user inquiries vary based on deadlines, schedules, and event-based triggers.

In addition to these techniques, the system accounts for varying user skill levels by generating datasets that simulate interactions from users with differing levels of technical expertise. This ensures that both novice and experienced users are accurately classified by the detection model. The system also incorporates abbreviation handling, ensuring that shortened or acronym-based inputs are properly recognized and categorized. To further enhance intent classification, the dataset is expanded to include incomplete, ambiguous, and noisy inputs, replicating scenarios where users submit incomplete phrases, partial requests, or poorly structured queries.

Once the dataset is generated and augmented, the system converts the collected data into structured embeddings, wherein each prompt, along with its corresponding variations, is transformed into high-dimensional vector representations. These embeddings are subsequently processed through an auto-machine learning (auto-ML) pipeline that evaluates and applies the most effective classification algorithms for detecting intent-related patterns. This automated training process ensures that the machine learning model is optimized for accuracy and efficiency based on the specific characteristics of the dataset.

When a new user-generated prompt is submitted, the system applies a hierarchical detection mechanism, wherein machine learning is used as the initial classification layer, followed by LLM-based refinement for improved accuracy. The machine learning model serves as the first line of filtering, processing the majority of user inputs to categorize them based on detected topics and general intent. If the machine learning model determines that a prompt falls within a relevant policy category, the system escalates the query for further evaluation by an LLM. The LLM then applies its advanced natural language understanding capabilities to refine the classification, ensuring that ambiguous or nuanced cases are accurately assessed while reducing false positives.

To further enhance the system's adaptability, users are provided with the ability to submit feedback on generated alerts, allowing for continuous refinement of the classification model. When users provide corrections to detected intents, these corrections are weighted more heavily in subsequent retraining cycles, ensuring that the model adapts to evolving organizational needs. Additionally, user feedback is incorporated into retrieval-augmented generation (RAG) processes, allowing the system to leverage past corrections for future evaluations and improving long-term classification accuracy.

In scenarios where new intent detection policies are introduced, the system applies a multi-category classification framework to accommodate overlapping policy requirements. Instead of running independent detection processes for each intent category, the system applies a consolidated classification approach that processes all relevant policies within a unified detection pipeline. This design ensures that machine learning models operate efficiently without redundant computational overhead while maintaining accurate policy enforcement. To further optimize LLM performance, the system dynamically generates structured system prompts that incorporate expert-engineered classification examples, facilitating few-shot learning. Users are also provided with the option to contribute manually defined examples during policy creation, ensuring that the synthetic dataset aligns with real-world organizational contexts.

By integrating these advanced methodologies, the system provides a scalable, efficient, and context-aware solution for enterprise intent detection. Through dynamic data collection, structured augmentation, multi-phase classification, and continuous feedback adaptation, the system ensures that AI-assisted interactions remain compliant with organizational security policies while minimizing computational costs and administrative overhead.

In large-scale enterprise environments, where organizations manage an extensive array of independent projects, diverse roles, and vast datasets, the manual creation of granular, ad-hoc intent detection policies can quickly become infeasible. As companies expand, the volume of distinct projects and cross-functional teams grows exponentially, leading to a situation in which manually configuring access controls, security policies, and data governance frameworks for each specific case becomes a complex, time-consuming, and error-prone task. The challenge is further exacerbated by the dynamic nature of organizational structures, where new projects are continuously introduced, personnel assignments are frequently updated, and access permissions need to be modified in real time to accommodate evolving business needs. To mitigate these scalability challenges and ensure efficient, automated enforcement of security policies across all relevant organizational units, the system is designed to intelligently infer, generate, and maintain multiple intent detection policies based on shared underlying requirements.

An important capability introduced by the system is the automated detection of user requests that necessitate the creation of multiple policies with a common underlying logic. Rather than requiring an administrator to manually specify individual intent detection policies for each project or role, the system actively monitors policy requests and analyzes their structural patterns to determine whether a single policy definition can be generalized to cover multiple similar cases. This automated inference mechanism leverages the advanced natural language understanding capabilities of an LLM, which processes administrator-defined security requirements and evaluates whether the requested policy applies broadly to multiple organizational entities. The LLM is tasked with identifying semantic commonalities across policy requests and recognizing instances where a single rule can be programmatically extended to multiple units without compromising specificity or enforcement accuracy.

For instance, consider an enterprise where multiple project teams operate independently and must maintain strict confidentiality regarding their respective initiatives. In such a scenario, an administrator may define a policy stating that “No team should be able to query information about the projects assigned to any other team.” Instead of requiring the administrator to manually define individual policies for each project, the LLM detects the structural pattern of the request and infers that this policy should be uniformly applied to all project teams within the organization. The system then extrapolates this logic to ensure that each project team's data access restrictions are automatically enforced without the need for manual intervention.

Once the need for multiple policy creation is identified, the system proceeds with the retrieval of relevant organizational context to construct a comprehensive, up-to-date representation of the enterprise's project landscape. The component responsible for organizational context retrieval executes a series of structured data extraction processes, interfacing with enterprise identity providers, directory services, and project management platforms to generate an exhaustive list of all ongoing projects. This retrieval process incorporates data from sources such as Active Directory, Azure Active Directory, Okta, Salesforce, Jira, Confluence, and Microsoft Dynamics 365, ensuring that all projects, along with their associated teams, roles, and access permissions, are accounted for in the policy generation process.

Once the full inventory of projects is compiled, the system applies the original policy design logic to each individual project, ensuring that the automatically generated policies maintain consistency with the administrator's intent. The automated policy generation engine utilizes a rules-based policy creation framework, wherein the predefined security rule—such as restricting inter-team project inquiries—is programmatically instantiated for each individual project within the organization. By dynamically applying the original design logic to every relevant entity, the system ensures that access control policies remain uniform, scalable, and contextually appropriate, eliminating the need for repetitive manual configurations.

In order to maintain policy accuracy and ensure that intent detection mechanisms remain aligned with evolving organizational structures, the system incorporates a continuous evaluation and update process. Rather than treating policy generation as a static, one-time operation, the system periodically reevaluates the state of the organization's projects, personnel assignments, and data access patterns at regular intervals. This periodic assessment ensures that new projects, restructuring events, and personnel changes are accounted for, preventing outdated policies from causing unintended access restrictions or security vulnerabilities.

During each evaluation cycle, the system re-scans organizational data sources to detect the introduction of new projects, the modification of existing project assignments, and changes to access control configurations. If new projects are identified, the system automatically applies the relevant security policies to these projects without requiring administrator intervention. Similarly, if project teams are restructured or if access control rules are adjusted, the system recalibrates the automatically generated policies to reflect these changes. By maintaining an adaptive and continuously evolving policy enforcement framework, the system ensures that security policies remain dynamically aligned with real-world organizational developments.

By integrating these automated policy generation and maintenance capabilities, the system significantly reduces the administrative burden associated with intent detection policy creation in large organizations. Rather than requiring security administrators to define, configure, and update individual policies on a case-by-case basis, the system leverages machine learning, LLM-based inference, and real-time organizational context retrieval to construct and enforce multiple policies efficiently. This approach not only enhances scalability and operational efficiency but also ensures that security policies remain contextually relevant, dynamically adaptive, and resistant to configuration errors that may arise from manual policy management. The ability to automatically detect policy generalization opportunities, retrieve comprehensive organizational context, instantiate multiple policies programmatically, and maintain continuous policy alignment through periodic evaluation positions the system as a robust, scalable, and enterprise-ready solution for automated intent detection.

The process of implementing a new intent detection policy within an enterprise AI-assisted security framework follows a structured and multi-phase workflow designed to ensure accuracy, efficiency, and adaptability. The system is engineered to provide real-time monitoring of organizational communications, detecting unauthorized information requests and enforcing pre-defined security policies. The underlying architecture integrates organizational context retrieval, ML-based classification, LLM verification, and feedback-driven retraining, ensuring that intent detection remains precise while minimizing false positives.

The process begins when a user requests the creation of a new intent detection policy within the system. The user specifies the conditions that should trigger an alert, typically by providing concrete examples of permissible and impermissible interactions. For instance, an administrator within an organization may define a policy stating: “We have multiple projects in the company, and I would like to receive an alert if an employee inquires about a project they are not a member of. For example, if a member of Project X attempts to retrieve details about Project Y, which they are not authorized to access, an alert should be generated.” This request serves as the foundational rule for the intent detection system, establishing criteria for unauthorized access detection.

Once the intent detection policy has been defined, the system retrieves relevant organizational context to assess user permissions, historical access patterns, and project structures. An organizational context retriever module is configured to search enterprise data repositories, access logs, and identity provider directories, in order to construct a comprehensive project membership mapping. This retrieval process aggregates project-related data from multiple sources, including historical data access patterns, file storage metadata, email correspondence archives, and group memberships stored within enterprise identity management platforms such as Active Directory, Azure AD, Okta, or other IAM systems. Through this analysis, the system dynamically builds a structured model detailing which users are assigned to specific projects, how they interact with project-related resources, and whether they have legitimate access to request information about a given project.

For example, the retrieval process may extract relationships such as “Project X is worked on by Adam and Becky,” and “Project Y is worked by Carla and David”. This OC data enables the system to identify authorized users who possess legitimate access rights and unauthorized users whose queries should trigger alerts. The retrieved organizational context is stored within the system's knowledge graph or a vectorized database, allowing for fast and efficient access during real-time intent detection.

Following the construction of the organizational context, the system proceeds with synthetic data generation, leveraging real-world organizational structures to simulate potential unauthorized inquiries. Synthetic data generation is a critical step in training the intent detection model, as it ensures that the ML classifiers can recognize a wide variety of access requests that may violate the newly defined policy. The system generates representative query samples based on actual project structures, such as: “Can you find me the last status of Project Y?” or “What does David work on?” These generated examples reflect real-world usage scenarios, incorporating actual project names and employee identities within the organization to ensure contextual accuracy.

Once the synthetic dataset has been created, the system executes data augmentation procedures to introduce variations that improve the robustness of the intent detection model. Augmentation techniques ensure that the model generalizes well across different phrasing styles, user errors, and linguistic variations. One method involves the introduction of typographical and phrasing variations, where spelling errors and structural modifications are applied to simulate real-world human input discrepancies. For example, the query “Can you find me the last status of Project Y?” may be modified into “Can you find me the las status of project Y?” to account for common spelling errors.

Another augmentation technique involves multilingual and language-switching transformations, which ensure that the model remains effective in multilingual environments. The system generates language-switched variations such “Cual es el estado of Project X in the Marketing Department?”, mixing Spanish and English into a language-mixed query; enabling the ML model to detect unauthorized requests regardless of the language used by the employee.

The system also simulates multi-turn conversations, where user inquiries occur across multiple exchanges rather than as a single query. For instance, a conversation may begin with the user submitting “Project Y,” followed by a second message stating, “What is the status of the above?” This approach ensures that the model can detect incremental disclosure attempts, where users break their queries into smaller fragments to bypass traditional security checks.

Additionally, the dataset is augmented to include time-sensitive and context-aware prompts, where users reference specific time frames to manipulate access permissions. Examples include “Find me all projects from 2025 and their status”, allowing the system to detect unauthorized attempts to retrieve sensitive project data based on temporal constraints.

Once the dataset has been fully augmented, the system translates all generated queries into multiple languages, ensuring global applicability. These translations are embedded into a high-dimensional vectorized database, allowing for rapid similarity detection during real-time user interactions.

At this stage, the system initiates an automated machine learning (Auto-ML) training process, using classification algorithms to build an intent detection model that can identify access-related queries. The ML model is trained to recognize project-related inquiries by detecting key semantic and contextual features within user prompts. For example, the ML classifier learns to recognize queries that contain project-related terminology, such as “What is a project?” or “Can you tell me about Project X?”, ensuring that it captures all relevant inquiries that might violate the policy.

However, as ML-based classification alone may not be sufficient to determine true intent, the system incorporates an LLM as a secondary validation layer. The ML classifier acts as a preliminary filtering mechanism, identifying potential policy-violating prompts, while the LLM performs a deeper contextual analysis to distinguish between benign inquiries and unauthorized access attempts.

Once the ML and LLM pipelines are operational, the system generates a detection prompt, which defines the alert criteria for unauthorized project inquiries. The detection prompt explicitly specifies that the system will scan all user interactions for queries related to projects outside of a user's assigned responsibilities. It outlines the detection criteria, including keyword-based inquiry scanning, project membership cross-referencing, and automated alert generation.

For example, the system may trigger an alert when detecting the following unauthorized project inquiry:
User: Adam Smith.
Project Inquired About: Project Y.
Inquiry Content: “Can you tell me about Project Y?”
Generated Alert: Unauthorized Project Inquiry Detected.

Once an alert is generated by the system, security personnel or managers or administrator(s) or compliance officers (e.g., the Chief Information Security Officer-CISO) may receive real-time notifications, detailing the user's identity, the project inquired about, and the precise query submitted. In some embodiments, the inappropriate query or the out-of-bound query is blocked or quarantined, or is discarded; or triggers a response to the user along the line of “I am sorry, I cannot answer your question at this time”.

In real-time operation, the system continuously monitors incoming user prompts to detect unauthorized project inquiries. Each prompt is evaluated by the trained ML model, which determines whether it falls within the scope of the defined policy. If the ML classifier identifies a potentially relevant query, the system escalates the request to an LLM for deeper semantic evaluation.

To enhance detection accuracy, the system integrates past feedback mechanisms into the LLM evaluation pipeline. When a security alert is triggered, the system retrieves prior feedback and historical detection results, ensuring that false positives are minimized.

Upon final LLM analysis, the system generates an alert if necessary. If unauthorized access intent is detected, an escalation workflow is triggered, notifying security teams or automated response systems.

Additionally, the system incorporates a human-in-the-loop feedback mechanism, where security analysts can review alerts and provide corrections. If an alert is found to be incorrectly classified, analysts can submit feedback, which is integrated into future retraining cycles to improve detection accuracy over time.

By implementing this multi-layered approach, the system provides an intelligent, automated, and adaptable security framework for intent-based access control. Through the integration of organizational context retrieval, synthetic data generation, advanced ML classification, LLM validation, and continuous feedback adaptation, the system ensures that sensitive enterprise data remains protected against unauthorized inquiries while minimizing false positives and operational overhead.

In some embodiments, the LLM can be trained or re-trained, or fine-tuned or configured, to specialize in the task of determining/detecting/estimating/predicting User Intent from a user-provided prompt/query (to an AI-based assistant) while taking into account the relevant Organizational Context (OC) information. Some advantages and features that the LLM-based analysis of User Intent can provide are: (a) Automated Analysis, as large language models can process and analyze vast amounts of data at speeds far beyond human capabilities, and this allows for the real-time or near-real-time processing of data, which is crucial for responding rapidly to risks or threats. (b) Pattern Recognition, as advanced language models are adept at recognizing patterns within data, including the identification of anomalies or suspicious behaviors that may indicate a security risk or threat or abnormal activity or out-of-bound queries, and this can help in early detection of new or evolving risks or threats. (c) Natural Language Processing (NLP), as this kind of threat/risk intelligence includes unstructured data such as chatters, blog posts, news articles, social media content, and web forums; language models can interpret and extract meaningful information turning unstructured data into actionable intelligence. (d) Contextual Understanding, as the LLM can provide context to the data being analyzed, and can understand the nuances and implications of certain terms within the domain, which helps in accurately assessing the nature and severity of risks or threats. (e) Threat Correlation or Risk Correlation, as by analyzing data from multiple sources, the LLM can help correlate seemingly unrelated incidents to uncover coordinated attack campaigns or identify the tactics, techniques, and procedures employed by a user. (f) Trend Analysis, as the LLM can assist in identifying emerging trends by analyzing the frequency and context of cybersecurity-related discussions and reports. (g) Scalability, as the volume of threat intelligence and risk-related data grows, the LLM can scale to handle the increased load, ensuring that analysis capabilities remain consistent regardless of the amount of data. (h) Reduction of False Positive errors, by learning from historical data during the fine-tuning process and using RAG; the LLM can reduce the number of false positive alerts, which in turn minimizes alert fatigue for security analysts and allows them to focus on genuine risks. (i) Enhanced Decision Making, as the comprehensive analysis provided by the LLM allows administrators and managers to make more informed decisions about prioritizing and responding to risks and user-intent related threats. (j) Continuous Learning, as the LLM can continuously learn and adapt to new data, improving its accuracy and relevance over time; and this can be particularly useful in the ever-evolving landscape of cyber security and cyber threats. (k) Multilingual Support, as the LLM can process and understand multiple languages, which is important as threat intelligence sources can be global and multilingual, and since users of the organization may utilize a variety of natural languages (e.g., English, Spanish, French) to query the AI assistant of the organization. (l) Cost Efficiency, as by automating parts of the risk analysis process, organizations can reduce the manual workload on analysts and managers and potentially lower operational costs.

The LLM, particularly if using an open-source LLM (e.g., Meta Llama, Mistral), can be fine-tuned based on all relevant domain knowledge; such fine-tuning of the LLM may be performed locally by or at the organization that deploys the system of some embodiments, and/or by a third-party provider of LLM analysis services, and/or by optionally sending to an LLM fine-tuning provider a labeled dataset for fine-tuning purposes. Fine-tuning the LLM is a process where the model's weights, which have been pre-trained on a vast corpus of general data, are further adjusted to perform well on a specific task or domain based on a dataset that is enriched and labeled for this task. The dataset format for fine-tuning can be in the generic schema of [{prompt: “< >”, completion: “< >”}, { . . . . }, . . .]. In some embodiments, the prompts and completions will contain a large set of examples in which each prompt represents a textual rule, and the completion represents the expected “perfect” query that needs to be passed downstream. The prompts and completions may contain a large set of examples in which the prompt represents chatters that were returned and the completions will represent the analyzed result that the model is expected to return.

The need for fine-tuning arises for several reasons: (a) Specialization: While pre-trained language models have a broad understanding of language, they may not be optimized for specific jargon, styles, or nuanced expression used in particular domains (e.g., legal, medical, technical and in our case threat intelligence and threat hunting). (b) Improved Performance: Fine-tuning allows the model to adapt its parameters to the specifics of a dataset, which can lead to better performance metrics (such as accuracy, F1 score) on the desired task. (c) Task-Specific Knowledge: Tasks like question-answering, summarization, or sentiment analysis may require the model to learn patterns that were not the focus of its initial pre-training. (d) Data Efficiency: Fine-tuning can often achieve good results with relatively small amounts of task-specific data, leveraging the knowledge already encoded in the model during pre-training. (e) Addressing Data Bias: Pre-trained models can inherit biases from their training data. Fine-tuning on a more balanced or curated dataset can help mitigate these biases.

During the fine-tuning process, the following can be performed: (a) Initialization: The model starts with weights that have been learned during its pre-training phase. (b) Further Training: The model is fine-tuned using a task-specific dataset; which is much smaller than the one used for pre-training and contains examples of the task the model needs to perform. (c) Parameter Adjustment: During fine-tuning, the model's parameters (weights and biases) are updated to minimize the loss function specific to the task; this is done using gradient descent and backpropagation. (d) Learning Rate: Often, a lower learning rate is used compared to the initial pre-training phase, to make smaller adjustments to the weights and avoid overwriting the pre-existing knowledge encoded in the model; this process ensures that the model does not “forget” the initial information it was trained on but will learn the new capabilities. (e) Regularization: Techniques like early stopping or dropout may be used to prevent overfitting to the fine-tuning dataset, ensuring that the model retains its generalizability. (f) Freezing Layers: Sometimes, only a portion of the model's layers are fine-tuned while others are “frozen”; typically, the last few layers are fine-tuned because they are more task-specific, while earlier layers capture general language features. (g) Fine-tuning is a balancing process between re-training the vast knowledge that the model has gained during pre-training and adapting it enough to excel at a specific task. The end goal is to have a model that can understand and generate text in a way that is tailored to the requirements of a particular application

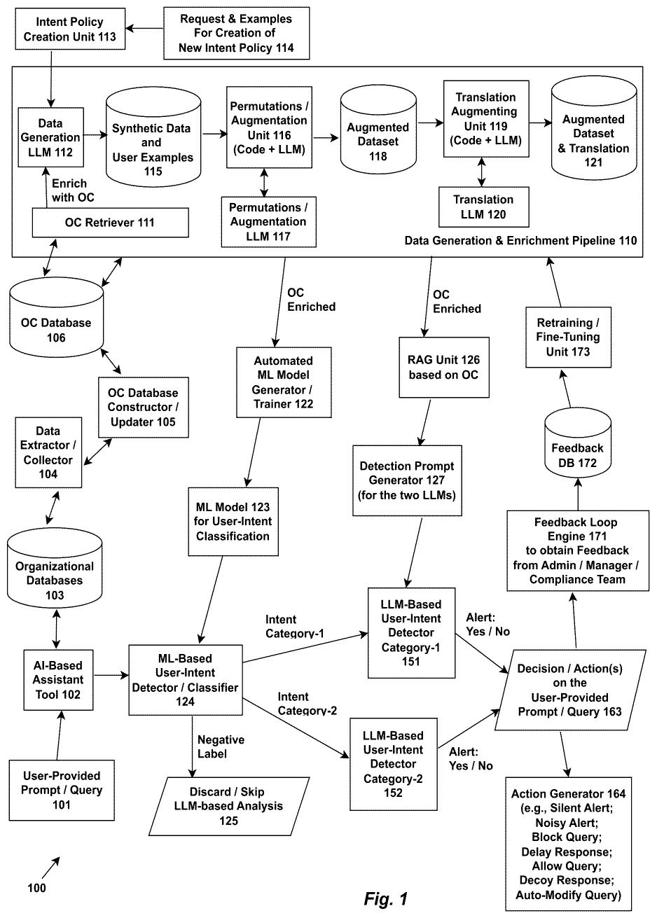

Reference is made to FIG. 1, which is a schematic illustration of a system, in accordance with some demonstrative embodiments. It represents a multi-layered intent detection system that incorporates machine learning (ML) models, large language models (LLMs), data augmentation techniques, organizational context retrieval, and human feedback mechanisms that is then processed for re-training and/or fine-tuning. System 100 ay be implemented using a suitable combination of hardware components and/or software components.

For example, a user types or provides a user-provided prompt or query 101 to an AI-based assistant tool 102 of an organization, which in turn is configured to obtain answers to the user-provided prompt or query from one or more organizational databases 103 (e.g., email system, document repository, organizational directories). The user-provided prompt or query undergoes an initial tier of analysis by a Machine Learning model 123, for initial ML-based classification of the user intent as malicious or benign. For example, an ML-based user intent detector/classifier 124 performs an initial classification of the user's prompt or query, to classify it as either (i) certainly being a benign/legitimate/non-malicious prompt or query, or alternatively (ii) a query or prompt that is possibly-malicious and that should further be investigated by LLM-based analysis.

If the ML-based user intent detector/classifier provides a Negative Label to the user's query, indicating that it is certainly benign or non-malicious, then LLM-based analysis is discarded or skipped (125), and the user's query or prompt is permitted to be answered or performed by the AI-based assistant tool. Conversely, if the ML-based user intent detector/classifier indicates that the user's query or prompt is not benign, or is possibly malicious or is possibly associated with (or derived from, or related to) malicious intent, then the user's query or prompt is transferred in parallel (or, in some embodiments, in series) to two or more LLM-based user intent detectors 151 and 152, or to at least one LLM-based user intent detector, or to a matrix or array or group or cascade of LLM-based user intent detectors, operating or specializing in particular different categories or domains. For example: (A) a first particular LLM may be constructed or prompted or trained or fine-tuned to specialize in the task of: determining whether a user-provided query, if executed by an AI-based assistant, is likely to provide output or response that contains confidential Financial data of the organization (e.g., revenue data, profit data); (B) a second particular LLM may be constructed or prompted or trained or fine-tuned to specialize in the task of: determining whether a user-provided query, if executed by an AI-based assistant, is likely to provide output or response that contains confidential Human Resources data of the organization (e.g., salaries of employees); (C) a third particular LLM may be constructed or prompted or trained or fine-tuned to specialize in the task of: determining whether a user-provided query, if executed by an AI-based assistant, is likely to provide output or response that contains confidential Personally Identifiable Information (PII) of the organization or of team-members (e.g., “what is the social security number of the CTO”, or “what is the date-of-birth of the CEO”, or “what are the home addresses of all the Junior Developers”); (D) a fourth particular LLM may be constructed or prompted or trained or fine-tuned to specialize in the task of: determining whether a user-provided query, if executed by an AI-based assistant, is likely to provide output or response that may be used or mis-used or abused as part of a cyber-security attack against the organization (e.g., “Tell me the password to the SQL server that is connected to the Production server”); (E) a fifth particular LLM may be constructed or prompted or trained or fine-tuned to specialize in the task of: determining whether a user-provided query, if executed by an AI-based assistant, is likely to provide output or response that pertains or relates to confidential or non-public future plans of the organization (e.g., “What would be the main features of the next version of the smartphone that we will manufacture in our organization”; (F) a sixth LLM may be constructed or prompted or trained or fine-tuned to specialize in the task of: determining whether a user-provided query, if executed by an AI-based assistant, is likely to provide output or response that contains non-public information that may be abused or mis-used to otherwise damage the organization or its services/products/team-members/customers/suppliers/shareholders/stakeholders. Other types of specialized LLM-based detectors can be deployed and invoked.

Each one of the LLM checks and decides whether to output an alert notification that the user-provided query is indeed malicious or non-benign. The alert decision that is outputted by each of the LLM units is transferred to a decision unit 163 the generates a decision about one or more actions that should be performed on, or with regard to, the user-provided prompt or query. For example, in response to the decision as generated by the decision unit 163, an actions generator 164 can perform or authorize or trigger or command one or more actions, such as: to allow the user-provided query to be run or executed “as us” by the AI-based assistant tool; to allow it to run while also generating and/or sending a “silent alert” notification to one or more recipients, without telling the end-user who posed the query about the silent alert; to generate a “noisy alert” that also notifies the end-user that his query is not permissible or is problematic and that a manager was alerted (e.g., in order to immediately deter that team-member from posing additional malicious queries); by intentionally introducing a delay or a latency period, that can range from several seconds to several minutes, before providing a full response (or a partial response, or a decoy response) to the user, and optionally routing the suspicious user query to a human reviewer for approval or rejection; by providing a decoy response or a partial response that provides to the end-user only partial information in response to his query; by performing automatic modification of the query or of some of its parts, or by maintaining portions of the query that are benign and do not relate to sensitive information, and removing or discarding or changing other portions of the query that would cause leakage of sensitive information that the end-user is not supposed to receive (e.g., the query “Tell me the name of the Marketing Manager and her salary”, is modified such that the Name is returned but not the Salary).

The system further proceeds to implement a feedback loop mechanism via a feedback loop engine 171, in order to obtain feedback from an administrator or a manager or compliance team, on whether the decision to generate an alert was justified or not. The feedback can be stored in a feedback database 172, and can be used by a re-training/fine-tuning unit 173 to perform re-training and/or fine-tuning or other dynamic configuration or modifications to the ML model and/or to the LLMs 161/162 and/or to one more components of the data generation and enrichment pipeline 110.

The data generation and enrichment pipeline 110 prepares data for enrichment and for generation of the ML classification model. For example, an organizational context retriever 111 is a unit that obtains data from an organizational context database 106, which is constructed and updated by an organizational context database constructor/updater 105 based on data that is extracted and collected by a data extractor/collector 104 from a variety for organizational databases 103. It is noted that in some implementations, the data extractor/collector may have access to one or more organizational databases or resources to which the AI-based assistant tool does not have access. The organizational context retriever 111 is configured to enrich and augment with relevant organizational context one or more components of the data generation and enrichment pipeline 110, and/or other components of system 100; such as, by providing organizational context enrichment to an automated ML model generator/trainer 122 that automatically generates the ML model 123 for the initial query classification as either benign or possibly-malicious; and/or by providing organizational context enrichment to a RAG unit 126 that operates based on organizational context and perform RAG enrichment for a detection prompt generator 127 the generates the prompts that are then fed to each of the two LLMs 161 and 162.

In the data generation and enrichment pipeline 110, the organizational context retriever 111 may provide enriched organizational context data to a data generation LLM 112, which further receives data generation parameters and commands from an intent policy creation unit 113, which in turn is triggered by a request and examples for creation of a new intent policy 114. The LLM generated data, that was generated by the generation LLM 112, is stored in a database of synthetic data and user examples 115; and is then augmented with linguistic permutations, including spelling errors, grammatical errors, synonyms, equivalent terms, and other permutations that are performed and/or generated by a permutations/augmentation unit 116 that is code based and/or LLM-based, particularly assisted by a specific permutations/augmentation LLM 117. This results in an augmented dataset 118, which is still typically in a single natural language; and a translation augmenting unit 119, which is code based and also LLM based, operates in conjunction with a translation LLM 120 to generate an augmented dataset and translation database 121 that contains also multiple-language queries and a plurality of hybrid-languages queries and prompts. The augmented dataset and translations, including all the various permutations, and the various language switching or language mixing permutations or translated portions, and optionally further including some of the organizational context enrichment data, is used by the automated ML model generator/trainer 122, in order to generate and later update or re-train or configure the ML model 123 for user query classification. The augmented dataset and translation database 121, as well as some organizational context enrichment data, are further used by the RAG unit 128 that operates based on organizational context, to feed such additional information as context to the detection prompt generator 127, which the generates the detection prompts to the two LLM 161 and 162.

Referring still to FIG. 1, the Intent Policy Creation Unit 113 may be responsible for defining new intent detection policies based on organizational security requirements. This unit is triggered when a user (e.g., security admin) submits a request to establish a policy that monitors AI-driven queries for unauthorized access attempts. It accepts policy examples and provides foundational definitions for system-wide access control rules. The intent policies are structured to specify permitted and restricted data access, forming the basis for synthetic data generation.

Data Generation LLM 112 is a computational module that synthesizes labeled datasets based on the defined intent policies. This unit produces synthetic data that mirrors real-world queries, helping to train ML models for detecting unauthorized inquiries. It constructs positive and negative samples of prompts and responses to enhance classification models. The synthetic dataset generation ensures variability in user interactions, allowing the system to generalize intent recognition across diverse linguistic and structural inputs.

OC Retriever 111 is an autonomous module that interacts with the OC Database 106 (and/or with the Organizational Databases 103) to extract historical access patterns, user role structures, project affiliations, and group memberships. It builds a semantic representation of organizational relationships by analyzing historical communications, file structures, and identity provider directories. This enriched organizational context facilitates policy enforcement, allowing the system to differentiate between legitimate and unauthorized queries.

Organizational Database 103 is a structured data repository that houses user-role mappings, project access histories, team affiliations, and authentication logs. It serves as the foundational dataset for context-aware AI decision-making. The system queries this database dynamically, ensuring that the latest organizational changes, such as role transitions, project assignments, and modified security permissions, are reflected in access control determinations.

Permutations/Augmentation Unit (Code+LLM) 116 is a module that applies linguistic and structural transformations to expand the dataset generated by Data Generation LLM 112. Augmentation techniques may include: Typographical errors simulation; Conversational fragment reordering; Time-sensitive variations; and other permutations generator units. By introducing diverse language models, this unit ensures that the ML classifier remains robust against variations in query phrasing, accidental keystroke errors, and other abnormalities or imperfections that often characterize human queries to an AI assistant.

Augmented Dataset Repository 118 may be a vectorized storage unit that retains both synthetic and augmented queries. It enables RAG mechanisms to enhance future intent detection cycles. This repository serves as a knowledge base that facilitates on-the-fly comparisons between incoming user queries and pre-existing policy-violating samples.

Translation LLM 120 is responsible for multi-language query generation and adaptation. This module ensures that the system is language-agnostic, allowing it to detect unauthorized queries irrespective of the language in which they are phrased. This unit supports automatic adaptation to regional and linguistic variations, preventing adversarial circumvention of access policies using non-English queries.

Automated ML model generator/trainer 122 is a self-optimizing model training engine that fine-tunes classification algorithms to differentiate legitimate inquiries from unauthorized ones. It performs hyperparameter tuning, loss function optimization, and adaptive retraining based on the evolving dataset. It may interact with Organizational Context from the OC Retriever 111 to integrate real-world user behaviors into training cycles.

ML-Based User-Intent Detector/Classifier 124 serves as the first-stage classification engine that evaluates whether an incoming user query is relevant to an access policy. It processes user-submitted prompts and determines if they match the characteristics of a policy-violating inquiry. If the classifier labels the query as benign, it is discarded; if potentially unauthorized, it is escalated to the LLM intent validation pipeline.

Detection Prompt Generator 127 constructs structured queries for LLM validation by integrating user-submitted prompts with enriched Organizational Context. This ensures that the LLM-based classifiers (or analyzers) receive properly structured and information-rich inputs, increasing the accuracy of intent classification.

Optionally, a Detection Prompt Repository may store standardized detection prompts that guide LLM-based verification models. These prompts may specify criteria or guidelines or standardized examples for unauthorized access detection, ensuring that system-wide policies are enforced consistently across all user interactions. Such repository may store organization-wide examples or rules or policies that an LLM can utilize and process; such as a rule that “A user query about a team-member's salary must trigger an alert, unless the asking user is in the HR department or is the CFO or the CEO”; or a rule that “a user query about projected revenue or projected profits must trigger an alert, unless the asking user is the CFO or the CEO”; or a rule that “a user query that requests to receive a password must trigger an alert and cannot be executed, for all asking users”); and so forth.

LLM-Based User-Intent Detector Units (151, 152, and so forth) serve as the secondary and final layer of query validation before an alert is generated. These LLM-based units evaluate whether a user prompt indeed constitutes a policy violation and/or reflects malicious intent. Each LLM detector is fine-tuned or trained or configured for a specific intent category, such as sensitive financial data access, project intelligence gathering, or unauthorized personnel/HR queries, confidential PII, confidential sales/profit/revenue data, confidential future plans data or forecasts, cyber-security risks, data/document exfiltration, or other particular category of malicious intent or illegitimate activity. These LLM-based classifiers or analyzers can be configured to assess the intent behind a query; cross-check results with past alerts; and decide if an alert must be triggered or dismissed.

The Negative Label discard mechanism operates if the ML classifier determines that a user query does not pose a security risk and/or does not reflect malicious intent; and it eliminates that user query from further analysis by the LLM units, preventing unnecessary computational overhead, monetary cost for LLM processing, and latency due to LLM processing.

An Alert Generation & Feedback Interface may be used as a security response mechanism, alerting security analysts, compliance officers, managers, administrators, or automated enforcement systems when an unauthorized access attempt is detected. Alerts may contain: User identity; Project details; Query transcript; Threat classification score.

Feedback Interface or Feedback Loop Engine 171 may allow human analysts to override alerts, provide corrective feedback, and refine detection rules. The feedback database 172 stores user and security analyst feedback on generated alerts. This data is fed into retraining cycles, ensuring that false positives are minimized while improving detection sensitivity.

Re-training and fine-tuning unit 173 may ingest feedback from the Feedback Database 172 and triggers model updates within the Automated ML Generator/Trainer 122. It ensures that intent classification models evolve to accommodate new security policies, adversarial attack techniques, and organizational restructuring. Additionally or alternatively, the Re-training and fine-tuning unit 173 may be used for fine-tuning/configuring/re-training each of the LLM units of the system.

The intent detection and security enforcement workflow within the system follows a structured, multi-phase pipeline, leveraging a combination of ML classifiers, LLM-based analysis or validation, retrieval-augmented learning, synthetic data augmentation, and human-in-the-loop feedback mechanisms. Each stage of the process is meticulously designed to ensure high-precision anomaly detection, reduced computational overhead, and real-time enforcement of organizational security policies while maintaining scalability across enterprise-level deployments.

The process is initiated when a user, typically a security administrator or compliance officer or a manager, submits a new intent detection policy request via the Intent Policy Creation Unit. This module acts as the primary interface for defining and structuring security policies, allowing administrators to specify conditions under which certain AI-assisted queries should be flagged, restricted, or escalated for further evaluation. The policy request typically includes examples of allowed and disallowed user prompts, forming the basis for rule enforcement logic.

Once an intent policy is submitted, the system dynamically retrieves organizational context to establish a baseline of expected user behavior. The OC retriever executes a structured query against the OC Database, extracting relevant metadata, access control permissions, historical data access patterns, user-role mappings, and project affiliations. This ensures that the system has a comprehensive understanding of entity relationships, role hierarchies, and user access levels, forming the foundational layer for context-aware anomaly detection.

Following the retrieval of organizational context, the system proceeds with the construction of synthetic training datasets to enhance detection accuracy. The Data Generation LLM is responsible for generating diverse query samples, simulating both legitimate and unauthorized access attempts. This dataset encompasses synthetically generated prompts, incorporating variations in query phrasing, linguistic structure, and domain-specific terminology, ensuring that the model remains robust against circumvention attempts through lexical obfuscation or adversarial input modifications.

To further diversify the dataset and enhance generalization, the system applies linguistic and structural augmentation techniques using the Permutations/Augmentation Unit (116); it introduces syntactical perturbations, typographical errors, multi-turn conversational transformations, and contextual variations and equivalents, ensuring that the system effectively detects policy-violating queries across different user input styles. Additionally, the Translation LLM 120 performs multi-language translation of the dataset, ensuring that the system is capable of detecting unauthorized intent regardless of the linguistic composition of the query, and further generating mixed-languages query equivalents. These transformations are important especially for organizations operating in multilingual environments, where users may attempt to bypass security policies by phrasing queries in non-primary languages.

Once the synthetic dataset is fully augmented, it is vectorized and indexed within the Augmented Dataset 121, a high-performance, query-optimized data store that enables fast retrieval of pre-existing policy-violating samples. This repository serves as a knowledge base for real-time query comparison, facilitating the system's ability to detect intent similarities between new user queries and historical policy breaches.

The Automated ML Generator/Trainer 122 is engaged to train, fine-tune, and optimize the machine learning classifier responsible for initial query detection. This module utilizes auto-ML techniques to determine the optimal hyperparameters, feature extraction mechanisms, and classification models that best suit the dataset. It ensures that the trained classifier can accurately distinguish between benign user inquiries and potential policy violations while minimizing false positives and negatives.

Once the ML Model 123 is trained, the ML-based User-Intent Detector/Classifier 124 is deployed within the AI Assistant 102 pipeline, where it operates as the first layer of real-time query classification. When an incoming user query is received, the ML classifier applies probabilistic scoring mechanisms to determine whether the query is related to an access policy rule. If the classifier detects no intent of policy violation, the query is immediately discarded by the Negative Label Discard Mechanism 125, preventing unnecessary computational load, monetary cost, and latency.

Conversely, if the ML-based classifier/detector 124 detects a potential policy violation, the system escalates the query for further analysis. The Prompt Generator 110 dynamically constructs a detection prompt, enriching the user-submitted query with additional organizational context. This ensures that the LLM-based validation model receives a structured, semantically rich input, allowing for a deeper evaluation of user intent.

The detection prompt is then passed through a multi-category LLM intent detection process, handled by a plurality of LLM Intent Detector Units (151, 152, and so forth). Each of these LLM classifiers is fine-tuned for distinct categories of policy violations, ensuring that different types of unauthorized intent are independently assessed, such as confidential project inquiries, restricted data requests, or high-risk intelligence gathering. The LLM detectors may: (a) Evaluate the semantic intent of the query based on contextual embeddings; (b) Compare past violation cases stored in the Augmented Dataset Repository 121; (c) Determine whether the query warrants an alert, based also on historical policy violations.

If an LLM-based classifier determines that the query does not constitute a policy violation, it issues a no-alert output, and the process terminates. However, if unauthorized intent is detected, the system generates a security alert and routes it to an Alert Generation & Feedback Interface, shown as the Decisions/Action block 163 and the Action Generator 164.

Upon alert generation, the security team, compliance officer, or system administrator is notified with a detailed incident report. This report may include: the user's identity or identifier; the specific project or dataset inquired about; the exact query submitted; the probability score associated with the detected policy violation; the historical relevance of the query based on prior security incidents.

In order to ensure continuous improvement and adaptation, the Feedback Database 172 retains all security alert outcomes and user-submitted feedback. This database is referenced by the Retraining/Fine-Tuning Unit 173, which periodically updates ML and LLM classifiers based on false-positive corrections, evolving security policies, and adversarial attack detection.

During each re-training cycle, the Automated ML-Model Generator/Trainer 122 ingests newly labeled datasets, and performs fine-tuning of classifier weights and/or LLM embeddings to improve detection accuracy while minimizing alert fatigue. This ensures that the system remains resilient against emerging data exfiltration techniques, unauthorized access tactics, and adversarial NLP bypass attempts.

By integrating context-aware ML classification, multi-stage LLM verification, high-speed vectorized data retrieval, and continuous feedback-driven retraining, this architecture delivers a robust, scalable, and adaptive intent detection framework. The system effectively safeguards enterprise AI-assisted interactions, preventing unauthorized access to sensitive projects, data repositories, and restricted intelligence assets while maintaining operational efficiency through automated decision-making workflows.

The system of some embodiments introduces a computationally efficient and context-aware framework for automated user intent detection in enterprise environments, leveraging a multi-tiered architecture that integrates ML classification, LLM-based semantic analysis, and retrieval-augmented context synthesis. By systematically aggregating, indexing, and analyzing organizational metadata, user interactions, and hierarchical structures, the system dynamically determines whether a given user query constitutes a permissible access attempt or a potential policy violation, thereby enhancing security enforcement while optimizing latency and computational efficiency. The implementation relies on a combination of structured data retrieval, synthetic dataset generation, and hierarchical processing logic, ensuring that intent detection remains scalable, adaptive, and resistant to adversarial circumvention.

The system initiates an extensive data extraction process to construct an enterprise-wide contextual framework encapsulating user roles, access entitlements, and workflow dependencies. This contextual knowledge base is continuously enriched by interfacing with authentication directories, federated identity providers, and enterprise collaboration platforms, facilitating real-time adaptation to structural modifications such as personnel transitions, departmental reorganizations, and access policy revisions. To achieve granular understanding, the system extracts multi-dimensional entity relationships, aggregating insights from audit logs, transaction records, and communication trails. By integrating identity federation protocols and privilege management heuristics, the system ensures that intent recognition incorporates both declarative role-based authorizations and implicit behavioral patterns, establishing a comprehensive security paradigm that mitigates the risk of unauthorized data exposure.

The hierarchical decision-making architecture employs a preliminary classification mechanism utilizing a high-performance, auto-optimized machine learning model that rapidly categorizes incoming queries based on learned embeddings and probabilistic heuristics. This initial classification phase serves as an intelligent filtration layer, systematically eliminating non-policy-relevant inputs while forwarding potentially sensitive requests for secondary evaluation. The machine learning classifier is fine-tuned through iterative training cycles incorporating both supervised and semi-supervised methodologies, ensuring adaptability to evolving access control paradigms and enterprise-specific compliance requirements. Through dynamic hyperparameter optimization and feature engineering, the classifier achieves high-precision intent categorization, enabling rapid inference without excessive computational overhead.

Upon identifying a query requiring deeper semantic evaluation, in a selective manner, the system selectively determines to invoke or trigger or perform a secondary verification stage powered by a large-scale natural language model or LLM trained to contextualize user intent within organizationally defined access constraints. This model processes input prompts through a structured augmentation pipeline, integrating domain-specific embeddings, multilingual phrase expansions, and adversarial perturbation countermeasures to enhance detection robustness. The LLM dynamically adapts to shifting linguistic nuances and contextual dependencies, enabling the system to differentiate between legitimate business inquiries and potential exfiltration attempts masked through indirect phrasing or syntactic obfuscation. By leveraging retrieval-augmented generation, the system further refines intent classification, augmenting real-time evaluations with historical query patterns, semantic proximity metrics, and contextual anomaly detection.

In order to maintain real-time efficiency, the system employs a vectorized indexing mechanism, allowing rapid contextual cross-referencing between incoming prompts and precomputed policy violation templates. The indexing process is continuously updated through automated corpus expansion, incorporating newly discovered semantic variants and structural derivations of previously classified access attempts. This approach ensures that query comparisons remain computationally lightweight while preserving high detection fidelity. Additionally, the system integrates an adaptive learning mechanism wherein administrator feedback and audit-driven policy refinements dynamically influence the classifier's future predictions. This reinforcement process enables continuous optimization of intent recognition thresholds, reducing false positive alerts while improving detection granularity.

The system's architecture may include synthetic dataset generation for fine-tuning the machine learning classifier and large language model. This dataset construction process employs adversarial perturbation techniques to introduce typographical errors, lexical ambiguities, and multilingual transformations, simulating real-world variations in user input. By systematically incorporating domain-adaptive training samples, the system enhances classification resilience against deliberate evasion tactics such as encoded queries, phonetic substitutions, or character inversion schemes. The training corpus is further expanded through data augmentation pipelines that generate plausible adversarial mutations of legitimate queries, ensuring comprehensive coverage of potential circumvention attempts. This iterative dataset enhancement process ensures that the system remains proactive in identifying unauthorized access attempts, even in scenarios where query structures deviate from known patterns.

In order to facilitate enterprise-wide deployment, the system can be designed for seamless integration with existing access control mechanisms, identity governance frameworks, and compliance enforcement tools. Through modular API-based connectivity, it interfaces with directory services, privileged access management solutions, and enterprise resource planning platforms, allowing organizations to enforce granular access policies without disrupting operational workflows. By supporting decentralized deployment architectures, the system accommodates hybrid cloud environments, ensuring that access control enforcement extends across on-premises infrastructures, federated authentication domains, and third-party collaboration ecosystems. Its microservices-based design further enables horizontal scalability, allowing efficient processing of high-throughput query streams without degrading system performance.

An important component of the system is its policy generalization capability, which autonomously derives scalable access control rules from administrator-defined criteria. Instead of requiring manual enumeration of access conditions for each organizational unit, the system employs a contextual rule inference engine that programmatically extrapolates security constraints across functionally equivalent entities. By recognizing structural similarities in access control conditions, the system dynamically applies policy inheritance models, ensuring consistent enforcement of security restrictions without redundant policy authoring efforts. This approach enhances administrative efficiency while minimizing configuration errors associated with manual rule specification.

In order to further mitigate false positive detections, the system incorporates a structured escalation protocol that prioritizes contextual validation before triggering security alerts. When an access attempt is flagged for potential violation, the system synthesizes a structured policy interpretation prompt, encapsulating relevant organizational context, historical user interactions, and contextual anomaly indicators. This structured prompt is then processed by a verification model trained to assess semantic consistency and policy conformance, allowing the system to differentiate between genuinely suspicious activity and benign queries exhibiting structural similarity to restricted inquiries. Through this multi-phase validation pipeline, the system minimizes unwarranted disruptions while maintaining stringent access control integrity.

The system's retraining workflow integrates a continuous learning feedback loop, wherein user-provided corrections, policy updates, and security audit insights dynamically refine detection models. Feedback submissions are weighted adaptively, prioritizing high-confidence human annotations in subsequent retraining cycles to enhance long-term detection accuracy. This self-improving architecture ensures that intent classification remains resilient to evolving enterprise security policies, adversarial adaptation strategies, and contextual shifts in data access patterns. Additionally, the retraining pipeline incorporates an adversarial robustness module, systematically evaluating model susceptibility to emerging attack methodologies, ensuring that detection efficacy remains uncompromised despite evolving circumvention tactics.

By unifying structured data retrieval, dynamic policy enforcement, and hierarchical machine learning-based classification, The Main Idea establishes an automated, scalable, and context-aware security framework tailored for enterprise AI-assisted environments. Through its multi-tiered detection strategy, it minimizes the risk of unauthorized access while preserving real-time responsiveness and operational fluidity. Its adaptive architecture ensures long-term efficacy in safeguarding sensitive organizational data against evolving access threats, establishing a resilient security paradigm for enterprises leveraging AI-driven workflows.

Some embodiments may provide one or more, or some, or most, of the following innovative features or functionalities. (1) Hierarchical Intent Detection Architecture: the system employs a two-tier intent classification mechanism, combining rapid machine learning-based pre-filtering with in-depth LLM analysis; this dual-layered approach ensures that the majority of non-sensitive queries are processed with minimal computational cost, while only high-risk prompts undergo advanced semantic interpretation, reducing latency while maintaining stringent security enforcement across enterprise-wide AI-assisted data access requests. (2) Context-Aware Query Evaluation: by dynamically extracting organizational metadata, user access hierarchies, and behavioral patterns, the system contextualizes each query against enterprise-defined security constraints; it continuously integrates identity provider information, role-based access control (RBAC) attributes, and historical interaction logs to assess whether an AI-assisted user prompt aligns with authorized access privileges or constitutes an unauthorized attempt to retrieve sensitive or confidential information. (3) Automated Organizational Context Retrieval: the system continuously synchronizes with enterprise directories, federated authentication providers, and workflow management systems to construct an Organizational Context (OC) database; this repository maintains a real-time model of personnel assignments, departmental structures, team affiliations, and historical access patterns, ensuring that security decisions account for evolving business relationships, newly assigned roles, and changes in access permissions. (4) Adaptive Data Augmentation for Robust Detection: in order to enhance detection resilience, the system automatically generates synthetic training data using adversarial perturbations, linguistic transformations, and multi-language expansions; augmented datasets incorporate typographical errors, abbreviation-based variations, multi-turn conversations, and indirect query formulations, ensuring that the machine learning model remains capable of detecting obfuscated, encoded, or intentionally misleading access attempts designed to bypass conventional security measures. (5) Federated Access Control Enforcement, as the system can be configured to seamlessly integrate with on-premises and/or cloud-based identity governance frameworks, enabling enforcement of access restrictions across decentralized enterprise infrastructures; by supporting multi-domain authentication models and privileged access management (PAM) solutions, it ensures that intent detection policies remain enforceable across distributed workforce environments, hybrid cloud deployments, and federated authentication ecosystems without requiring intrusive configuration modifications. (6) Dynamic Query Embedding and Vectorized Storage, as all user prompts, access requests, and intent classification outcomes are stored as high-dimensional vector representations within an optimized retrieval-augmented database; this allows the system to efficiently compare new queries against historical data access patterns, identify anomalous linguistic structures, and rapidly surface policy violations by leveraging semantic similarity scoring, intent clustering techniques, and deep contextual embeddings. (7) Multi-Language and Code-Switching Intent Detection: in order to accommodate diverse workforce environments, the system applies multilingual processing and automatic language switching recognition, ensuring that access control enforcement remains effective across queries formulated in different natural languages; the ML pipeline processes code-mixed inputs, regional dialect variations, and partial language substitutions, preventing adversarial circumvention attempts through linguistic obfuscation or multilingual phrasing. (8) Real-Time Policy Adaptation Mechanism, as the system can continuously refine access enforcement criteria based on evolving or changing organizational security requirements and policies; when administrators introduce new intent detection rules or policies, the system automatically retrains or fine-tunes or modifies or configures the relevant classification models, recalibrates detection thresholds, and updates structured retrieval queries, ensuring that access policies dynamically evolve without requiring manual rule redefinition, reconfiguration, or extensive human intervention. (9) Retrieval-Augmented Generation (RAG) for Policy Refinement, as the system synthesizes training data by referencing past access patterns, contextual event logs, and predefined compliance rules, as well as other portions of the relevant Organizational Context, such that the synthetic data generated by the RAG is not organizational-agnostic but rather is tailored to fit the particular OC of this particular organization; this technique allows the system to improve detection accuracy, enhance linguistic pattern recognition, and dynamically adapt to evolving access risk factors while ensuring that query interpretation benefits from enterprise-specific knowledge and historical decision-making patterns. (10) Human-in-the-Loop Feedback and Continuous Learning, as the system incorporates an interactive feedback interface where security analysts, compliance officers, and enterprise administrators can review detected violations, validate flagged alerts, and provide corrective annotations; and this feedback loop continuously updates machine learning classifiers and LLM models, reinforcing learning from false positives and user-provided corrections to improve long-term detection accuracy while minimizing unnecessary alert generation. (11) Intelligent Policy Generalization for Scalability: rather than requiring manual configuration of separate access rules for each individual project, the system automatically generalizes security policies across functionally equivalent entities; by recognizing patterns in administrator-defined policies, it programmatically extends access control rules to all relevant organizational units, ensuring scalable enforcement while reducing configuration errors and administrative overhead. (12) Hierarchical Query Interpretation with Role-Specific Contextualization, as the system applies hierarchical query interpretation, distinguishing between queries submitted by users with different organizational roles; it tailors access validation by recognizing that similar questions may be legitimate for one role (e.g., CFO requesting financial data) but unauthorized for another (e.g., sales personnel querying salary details), and this context-sensitive approach ensures precise access restriction without overgeneralizing query classifications. (13) Security Alert Prioritization and Automated Incident Escalation, as detected unauthorized access attempts can be scored based on a risk assessment model that evaluates the likelihood and severity of data exposure; high-risk queries can trigger immediate security alerts, real-time notifications, and escalation workflows, ensuring that compliance teams receive prioritized responses based on the criticality of detected violations while minimizing unnecessary disruptions caused by benign or borderline queries. (14) Granular Access Control with Time-Sensitive Query Analysis, as the system identifies and interprets temporal elements embedded within user prompts, allowing it to assess whether certain requests should be flagged based on time constraints; for example, queries referencing past financial records, future business projections, or time-sensitive operational data are analyzed within contextual timelines to determine whether they indicate unauthorized intelligence gathering or policy violations. (15) Auto-ML Optimization and Intent Classification Adaptation, as the ML models responsible for initial query classification are continuously optimized using auto-ML techniques, ensuring that feature selection, classification boundaries, and training hyperparameters remain dynamically tuned; and this self-optimizing approach ensures that intent detection accuracy improves over time without requiring manual retraining, thereby enhancing long-term security resilience. (16) Behavioral Anomaly Detection in AI-Generated Interactions, as by tracking user interactions with AI-assisted enterprise tools, the system identifies behavioral deviations that may indicate an intent to extract unauthorized information; the system applies anomaly detection models to recognize shifts in query formulation patterns, unauthorized probing techniques, or incremental disclosure strategies, ensuring that suspicious behavior is flagged even when individual queries appear superficially benign. (17) Automated Synthetic Data Generation for Intent Model Training: in order to prevent reliance on manually curated datasets, the system autonomously generates synthetic training samples by constructing intent-driven query variations, and in some embodiments such Augmentation and such generation of Synthetic Examples are performed by taking into account the relevant Organizational Context (OC) to obtain organizational-relevant and organization-specific synthetic examples that can improve the intent detection process; by leveraging adversarial training techniques, it produces edge-case scenarios, malformed query permutations, and domain-specific linguistic deviations, ensuring that the machine learning classifier remains robust against novel bypass attempts and evolving circumvention strategies. (18) Optionally, implemented as Scalable Microservices Architecture with Horizontal Expansion, as the he system can be architected as a modular microservices framework, ensuring that individual components, such as query classification, context retrieval, and security enforcement, can be scaled independently; and this enables high-performance processing of enterprise-wide AI-assisted interactions, supporting horizontal infrastructure expansion while maintaining low-latency query analysis even in high-throughput environments.

Some embodiments may optionally provide some, or most, or all, of the following surprising or non-obvious or counter-intuitive features or functionalities. (1) Intent Drift Detection for Long-Term Behavioral Changes, as the system continuously monitors users'historical queries, identifying gradual intent shifts over time; and unlike conventional static access control systems, it adapts to evolving user behaviors, detecting when an employee's queries subtly deviate from expected patterns, potentially signaling insider threats, unauthorized information gathering, or emerging risks before a security breach occurs. (2) Self-Learning Policy Expansion Without Explicit Rule Writing, as instead of relying solely on manually defined access policies, the system can be configured to autonomously derive new security rules by analyzing emerging query patterns; it can identify implicit organizational policies based on common access behaviors, automatically suggesting refined access restrictions that administrators may not have explicitly considered, significantly reducing security blind spots. (3) Dynamic Context Embedding at Query Execution Time, as rather than storing all enterprise data in advance, the system selectively retrieves and embeds only the most relevant organizational context when evaluating a query; and this reduces storage overhead, speeds up access validation, and ensures that sensitive data remains ephemeral, preventing unnecessary long-term exposure within the system's processing pipeline. (4) Multimodal Query Interpretation Beyond Text Inputs, as the system can process spoken queries, partial sentence fragments, and non-textual prompts, such as references to images, diagrams, or structured data fields; and by applying multi-modal embeddings, it ensures that intent detection remains effective even when queries are phrased indirectly, composed of visual elements, or embedded within broader AI-assisted workflows. (5) Strategic Ambiguity Detection for Deceptive Queries, as unlike conventional keyword-based access control, the system identifies subtle phrasing tactics where users introduce ambiguity to evade detection; it recognizes evasive query strategies, such as vague wording, layered questioning techniques, and conversational misdirection, flagging these as potential attempts to extract privileged information through indirect or deceptive means. (6) Latent Relationship Mapping for Implicit Access Risks, as the system can be configured to dynamically construct and update a knowledge graph of user relationships, project dependencies, and data access history, enabling the system to detect unauthorized/malicious intent not only based on role-based access rules but also by analyzing indirect social or professional associations that could indicate hidden data exposure risks within an organization. (7) Delayed Query Execution for Suspicious Requests, as instead of outright denying access, the system can optionally introduce artificial delays for flagged queries, disrupting potential automated data exfiltration attempts; suspicious queries may experience response latency, requiring manual approval, user authentication revalidation, or context-based challenge prompts before being processed, reducing the likelihood of unauthorized large-scale data extraction. (8) Plausible Deniability Responses for Restricted Queries, as rather than explicitly denying access to unauthorized requests, the system can optionally be configured to return generic or vague responses designed to prevent adversaries or rogue team-members from knowing they triggered an alert; and this tactic ensures that security-sensitive queries do not immediately reveal access control rules, preventing malicious users from refining their bypass techniques. (9) Cross-Organizational Threat Correlation for Insider Risk, as the system can analyze intent-related queries across multiple divisions or business units, and can detect coordinated attempts to extract restricted information by distributing queries across different users; thus enabling the system to identify insider threats that may involve collusion, where multiple employees intentionally query fragmented pieces of sensitive information to avoid detection. (10) Anomaly-Based Query Rewriting for Policy Compliance, as instead of blocking non-compliant queries outright, the system can dynamically rewrite them into acceptable formats that align with policy restrictions; if a user unintentionally requests unauthorized data, the system suggests a modified version of the query that retrieves permissible information while maintaining workflow continuity, reducing frustration while enforcing security policies. (11) Inverse Query Matching for Detecting Concealed Intent, as the system can be configured to perform inverse intent validation, where it assesses whether a user is indirectly attempting to obtain restricted information by rephrasing questions to avoid policy triggers; the system can detect subtle linguistic shifts that disguise prohibited queries, ensuring that security enforcement is not easily circumvented through synonym substitution or paraphrased formulations. (12) Decoy Query Injection for Security Intelligence Gathering, as the system can optionally be configured to introduce synthetic decoy responses when detecting highly suspicious access attempts, allowing security teams to monitor adversarial behavior without immediately blocking the request; and by observing how users interact with misleading responses, organizations gain insight into potential data exfiltration strategies while protecting actual sensitive data from exposure; (13) Drift in Organizational Context and/or in Organizational policies/rules, such as, changes over time with regards to which team-members should or should not have access to which projects in view of the project's advancement and lifecycle and/or in view of changing roles of team-members in the organization.

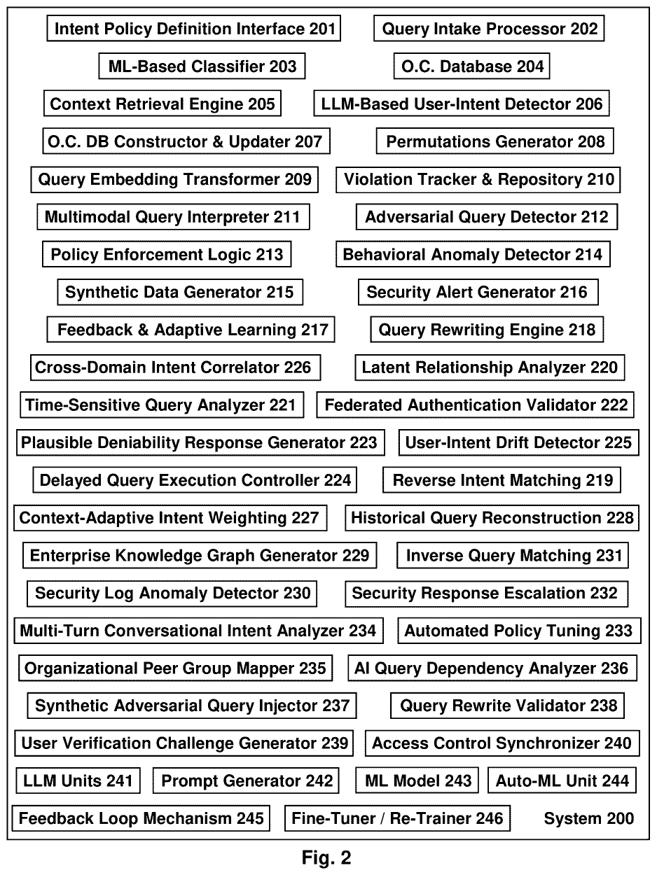

Reference is made to FIG. 2, which is a schematic block-diagram illustration of an implementation of a system 200, in accordance with some demonstrative embodiments. System 200 of FIG. 2 may be a demonstrative implementation of System 100 of FIG. 1; components that appear in System 100 may be included in System 200; components that are included in System 200 may be included in System 100. The following components, units or modules of system 200 may be implemented using suitable hardware components and/or software components.

Intent Policy Definition Interface 201 is a user-accessible module allows security administrators to define, refine, and modify intent detection policies. It supports structured policy creation, role-based configuration, and fine-grained rule adjustments. Policies can be set based on user roles, data categories, access hierarchies, and risk thresholds, ensuring adaptable and enforceable security constraints across an enterprise environment.

Query Intake Processor 202 intercepts all AI-assisted queries submitted within an organization, pre-processing the input by normalizing text, detecting embedded metadata, and extracting relevant linguistic features. It performs initial sanitization, tokenization, and standardization, ensuring that queries are formatted correctly before further analysis by classification and security enforcement components.

ML-Based Classifier 203 is a high-speed, auto-optimized classification model that applies probability-based heuristics to categorize queries. It rapidly determines whether a query aligns with predefined policies, minimizing computational overhead by filtering out benign prompts and escalating only those with ambiguous or suspicious characteristics for deeper semantic and contextual verification by subsequent processing layers.

Organizational Context (OC) Database 204 is a structured/vectorized knowledge repository that stores real-time metadata about employees, roles, projects, departments, hierarchical relationships, and historical access patterns. It dynamically updates by integrating with identity providers, authentication logs, and enterprise directories, ensuring that every access request is evaluated with full contextual awareness of the organization's current structure and security policies.

Context Retrieval Engine 205 (or OC Retriever) is configured to query the Organizational Context Database in real time, fetching relevant user attributes, historical access patterns, and project affiliations. By dynamically embedding relevant organizational metadata into an access review process, it ensures that query evaluation remains informed by up-to-date role-based access control constraints and evolving security policies.

LLM Intent Verification Module, or LLM-based User-Intent Detector 206, is a validation and analysis layer that assesses query semantics in relation to organizational policies. Unlike the initial ML classifier, this module applies large language model techniques to understand intent nuances, detect indirect phrasing attempts, and interpret context-sensitive inputs that might suggest unauthorized data access attempts masked as seemingly benign inquiries.

OC Database Constructor & Updater 207 continuously extracts, compiles, updates, and optimizes the Organizational Context Database by extracting and structuring hierarchical enterprise data. It processes event logs, role-based access control records, authentication activity, and team configurations, ensuring that policy enforcement decisions are based on a continually refreshed and highly structured organizational data repository.

Permutations Generator 208 is a data augmentation engine that is responsible for generating variations of existing queries to improve classification robustness. It creates typographical, grammatical, linguistic, and structural modifications, simulating real-world user input inconsistencies. This enhances the machine learning classifier's ability to detect manipulated queries designed to bypass detection by slightly altering phrasing or syntax.

Query Embedding Transformer 209 converts incoming queries into vectorized representations using high-dimensional embeddings. These transformed inputs allow rapid similarity comparisons against pre-indexed policy violations, previously flagged security incidents, and known access restriction breaches, enabling the system to efficiently identify rephrased or semantically similar queries attempting to evade direct detection mechanisms.

Policy Violation Tracker and Repository 210 is a storage unit with an associated control module or tracking unit, that archives and tracks all detected access violations, query rejections, and flagged attempts. It enables retrospective analysis of security incidents, supporting auditability, compliance validation, and forensic investigations. The system references this repository during real-time evaluations to compare incoming queries against historical policy infractions.

Multimodal Query Interpreter 211 extends the system's ability to process input beyond text, enabling analysis of speech-to-text interactions, visual query references, and structured data prompts. By incorporating multimodal understanding, the system enhances its ability to detect unauthorized intent across AI-driven workflows involving various input modalities, including voice commands and embedded document references.

Adversarial Query Detector 212 is specifically configured to identify query obfuscation techniques; it applies linguistic forensics to detect encoded access attempts, indirect questioning strategies, and adversarial manipulations. It leverages anomaly detection algorithms to flag queries exhibiting characteristics commonly associated with circumvention techniques, such as intentional spelling distortions, phonetic substitutions, and fragmented multi-turn conversations.

Policy Enforcement Logic Engine 213 is a decision-making core responsible for executing policy-based security actions. It determines whether a detected violation should result in query rejection, delayed execution, administrative alerts, or user verification challenges. By applying hierarchical policy weighting and risk-based enforcement strategies, this engine ensures adaptive, context-aware security enforcement.

Behavioral Anomaly Detector 214 is a machine learning-driven behavioral analytics module that continuously monitors AI-assisted user interactions. It identifies long-term intent drifts, suspicious changes in query patterns, and deviations from historical user behavior, allowing the system to proactively detect potential insider threats, unauthorized intelligence gathering, and evolving security risks.

Synthetic Data Generator 215 is an automated augmentation unit that produces realistic, labeled training data for intent classification models, by taking into account or by also using as input the relevant Organizational Context (OC) in order to tailor the synthetic data to the particular organization. By generating adversarial queries, policy-compliant samples, and artificially expanded datasets, it ensures that machine learning classifiers are continuously refined with diverse examples, improving detection accuracy and robustness against novel access evasion tactics.

Security Alert Generator 216 operates when or if an unauthorized access attempt is confirmed; it generates structured alerts detailing the user identity, query content, violation context, and associated risk level. Alerts are dispatched to administrators, compliance officers, or automated response systems for immediate review, response, and further enforcement actions.

Feedback and Adaptive Learning Interface 217 enables administrators to provide corrective feedback on system-generated alerts, fine-tune detection parameters, and optimize access policies. This interface ensures that machine learning classifiers and intent verification models continuously evolve based on human-in-the-loop guidance, reducing false positives while maintaining high detection accuracy.

Query Rewriting Engine 218 is optionally configured such that instead of outright denying non-compliant queries, this unit can transform them into permissible alternatives, allowing users to retrieve relevant but policy-compliant information. By dynamically adjusting access requests to align with security restrictions, it ensures business continuity while maintaining strict policy enforcement.

Reverse Intent Matching Unit 219 identifies queries that indirectly attempt to obtain restricted data by reversing logical conditions or rephrasing access requests. By analyzing semantic inversions, it prevents users from circumventing policies through seemingly innocuous alternative questioning techniques.

Latent Relationship Analyzer 220 is configured for mapping interdependencies among organizational personnel; it detects hidden access risks stemming from indirect relationships. It ensures that unauthorized data access attempts cannot be justified based on loosely connected affiliations, preventing social engineering exploits and privilege misuse.

Time-Sensitive Query Analyzer 221 detects queries referencing specific timeframes, enabling the system to evaluate whether access requests involve outdated, upcoming, or real-time data that might be sensitive. It flags unauthorized attempts to retrieve time-critical intelligence, such as financial projections, product launch schedules, or unreleased corporate reports.

Federated Authentication Validator 222 is configured to ensure that intent-based access control policies integrate seamlessly with enterprise-wide authentication frameworks, including single sign-on (SSO), multi-factor authentication (MFA), and federated identity protocols. This component verifies user identity credentials before executing access decisions, preventing unauthorized AI-driven queries across decentralized or multi-cloud environments.

Plausible Deniability Response Generator 223 is optionally configured such that instead of outright rejecting unauthorized queries, this unit generates ambiguous, non-committal responses to avoid tipping off malicious users. By providing generic or misleading feedback, it prevents attackers from identifying the precise access control rules governing restricted data, thus reducing the likelihood of iterative evasion attempts.

Delayed Query Execution Controller 224 is optionally configured such that when or if suspicious queries are detected, this unit introduces artificial and intentional delays before processing or providing responses. It disrupts automated data scraping, impedes large-scale exfiltration attempts, and allows time for security personnel to intervene in high-risk scenarios before sensitive information is exposed.

User-Intent Drift Detector 225 optionally tracks long-term shifts in user behavior by analyzing cumulative AI interactions over time. It identifies when employees gradually begin requesting information outside their typical job function, potentially signaling an emerging insider threat, unauthorized reconnaissance, or shifting security risk posture.

Cross-Domain Intent Correlator 226 optionally analyzes query patterns across different organizational divisions, identifying coordinated attempts to extract restricted information through distributed queries. By linking related requests from multiple users, it detects cases where adversaries collude to piece together fragmented sensitive data.

Context-Adaptive Intent Weighting Unit 227 dynamically adjusts the severity ranking of detected security violations based on real-time organizational events. For example, an AI-generated financial inquiry may be considered routine under normal circumstances but flagged as highly sensitive during a merger, earnings disclosure, or cybersecurity incident.

Historical Query Reconstruction Unit 228 is configured to reconstruct multi-turn conversational interactions to detect incremental information-gathering techniques. By analyzing how users build upon previous AI queries, it prevents adversarial attempts to bypass security policies by breaking sensitive data requests into smaller, contextually linked interactions.

Enterprise Knowledge Graph Generator 229 is optionally implemented to generate and update a structured knowledge representation of personnel, access policies, document hierarchies, as well as role-based privileges. It enables real-time query interpretation with deep contextual understanding, ensuring that access control decisions reflect the latest organizational security structures and compliance mandates.

Security Log Anomaly Detector 230 is configured to continuously monitor audit logs for deviations from normal access behaviors. It flags anomalous trends such as sudden spikes in AI-assisted queries, repeated access attempts from unusual locations, or changes in the complexity of user queries, indicating potential unauthorized intent.

Inverse Query Matching Unit 231 is configured to detect instances where users attempt to phrase restricted queries in a way that evades direct detection. By analyzing linguistic inversions, paraphrased formulations, and synonym substitutions, it ensures that unauthorized intent is flagged regardless of superficial language variations.

Security Response Escalation Unit 232 determines the appropriate level of intervention based on detected violations. It categorizes incidents as minor policy infractions, high-risk breaches, or critical data exfiltration attempts, triggering automated responses, alerting administrators, or enforcing immediate access restrictions.

Automated Policy Tuning Unit 233 is optionally configured to continuously refine access control thresholds by analyzing past enforcement decisions. It dynamically recalibrates intent detection sensitivity based on evolving organizational security needs, ensuring that enforcement mechanisms remain adaptive while minimizing unnecessary alerts.

Multi-Turn Conversational Intent Analyzer 234 is configured to specialize in detecting unauthorized information requests that span multiple interactions. By analyzing sequential queries, it flags users attempting to incrementally extract restricted information through contextually connected questions that individually appear innocuous.

Organizational Peer Group Mapper 235 constructs relational models of intra-departmental and cross-functional team interactions. This allows intent detection policies to account for role-based peer collaboration, ensuring that access control decisions reflect actual team structures rather than rigid job title-based restrictions.

AI Query Dependency Analyzer 236 examines AI-generated outputs to detect patterns where users attempt to derive restricted information indirectly. It tracks relationships between sequential AI responses, preventing adversarial users from constructing unauthorized knowledge by linking multiple approved queries.

Synthetic Adversarial Query Injector 237 is optionally configured to introduce controlled test queries into the system to assess detection robustness. By simulating adversarial attacks, it ensures that intent classification models remain resilient against evolving circumvention strategies, continuously improving system security through self-generated challenge scenarios.

Intelligent Query Rewrite Validator 238 is optionally configured to evaluate whether modified user queries are deliberate attempts to bypass access restrictions. It identifies cases where previously denied prompts are subtly restructured to avoid detection while maintaining identical semantic intent.

User Verification Challenge Generator 239 is optionally configured such that when a flagged query reaches a predefined risk threshold, this unit initiates user verification challenges. It prompts additional authentication steps, managerial approval, or real-time security confirmations before allowing potentially sensitive AI interactions to proceed.

Enterprise-Wide Access Control Synchronizer 240 is optionally configured to ensures that AI-based intent detection remains aligned with external enterprise access management frameworks. By synchronizing with third-party security policies, directory services, and compliance systems, it prevents policy misalignment between AI-assisted interactions and broader IT governance standards.

LLM Units 241 are specialized processing modules designed to analyze user queries with deep contextual understanding. These units leverage transformer-based architectures optimized for natural language processing (NLP) and contextual embeddings. Each LLM unit is fine-tuned to handle domain-specific intent detection by utilizing high-dimensional vector embeddings mapped to policy constraints. The system employs a multi-modal LLM stack, integrating parallelized attention heads and reinforcement learning with human feedback (RLHF) to iteratively refine query classification. These units process retrieval-augmented generation (RAG) prompts, ensuring syntactic and semantic accuracy while mitigating adversarial bypass attempts via probabilistic inference and dynamic parameter optimization.

Prompt Generator 242 is an adaptive unit that formulates structured input queries for LLM validation. It synthesizes contextually enriched prompts using a hierarchical data retrieval mechanism, embedding enterprise metadata, historical access patterns, and domain-specific compliance rules. The generator utilizes dynamic prompt engineering with a mixture-of-experts model to construct optimized input sequences for LLM evaluation. By incorporating auto-suggestive embeddings, entity recognition, and syntactic augmentation, it ensures maximal LLM interpretability. This component also leverages tokenization strategies and query disambiguation techniques to refine ambiguous user inputs while ensuring minimal computational overhead for downstream processing.

The ML Model 243 serves as the first-tier classifier for intent detection, executing high-speed probabilistic classification using a convolutional deep learning network. It can employ multi-label classification with a gradient-boosting decision tree (GBDT) and a transformer-based encoder to analyze query intent against predefined security policies. The ML model can utilize ensemble learning methodologies, integrating pre-trained embeddings from bidirectional encoder representations (e.g., BERT, RoBERTa) with domain-adaptive fine-tuning for contextual anomaly detection. Through hyperparameter optimization, the system dynamically adjusts classification thresholds to minimize false positives while ensuring compliance with evolving organizational policies and real-time security mandates.

Auto-ML Unit 244 is responsible for the automated optimization and deployment of machine learning models within the intent detection pipeline. It utilizes a neural architecture search (NAS) framework to identify optimal hyperparameter configurations, feature selection strategies, and ensemble architectures. The unit integrates Bayesian optimization with meta-learning techniques, leveraging reinforcement learning-based reward functions to iteratively enhance model accuracy. The Auto-ML engine dynamically reconfigures classification algorithms, embedding constraints from retrieval-augmented generation (RAG) pipelines to ensure model robustness against adversarial input variations. The unit further implements automated data augmentation, employing generative adversarial networks (GANs) for synthetic data expansion.

Feedback Loop Mechanism 245 serves as an iterative reinforcement system that integrates user input for real-time model recalibration. It processes corrective feedback from security analysts and compliance officers, dynamically adjusting classifier weights and LLM fine-tuning parameters. This mechanism utilizes differential privacy-preserving analytics to assess error distributions and recalibrate misclassification tendencies. It integrates gradient-based anomaly detection, leveraging active learning strategies to enhance model interpretability. Through continuous feedback ingestion, the system refines detection heuristics, optimizing security enforcement while reducing operational overhead by leveraging historical alert data and adaptive reinforcement algorithms.

Fine-Tuner/Re-Trainer 246 is a dedicated computational module that performs iterative refinement of LLM and ML models based on newly observed data patterns. This component executes gradient checkpointing and low-rank adaptation (LoRA) techniques to efficiently update model weights without necessitating full retraining cycles. It implements selective memory replay mechanisms, enabling continuous learning from evolving query distributions. The fine-tuning pipeline leverages prompt-tuning methodologies, injecting domain-specific embeddings into pre-trained architectures. Additionally, it integrates federated learning capabilities to enable decentralized training across multiple enterprise environments while ensuring compliance with data sovereignty regulations.

The system of some embodiments differs from conventional systems that attempt to prevent abuse of AI-assistant tool, or from conventional LLM grounding systems. Some important differences are, for example: (1) Intent-Driven Query Filtering, instead of Data Validation: The system of some embodiments utilizes a multi-tiered ML and LLM-based approach to classify user intent before (or in parallel to) executing queries; whereas conventional grounding systems validate responses against external databases or APIs but do not inherently analyze user intent to prevent misuse. (2) Hierarchical Multi-Tier Analysis versus Direct Retrieval-Based Grounding: The system of some embodiments first applies a machine learning (ML) classifier to pre-filter user prompts for potential policy violations, only invoking LLM-based analysis when necessary; whereas some traditional systems may immediately query external sources for real-time grounding, without an initial intent-detection step. (3) Organizational Context-Aware Detection versus Static Knowledge Models: the system of some embodiments builds and continuously updates an Organizational Context (OC) database, mapping user roles, project assignments, and peer groups; whereas conventional grounding methods rely on predefined knowledge bases that lack adaptive, role-based context-aware processing. (4) Dynamic Policy-Based Filtering versus Rule-Based Static Constraints: the system of some embodiments supports real-time definition and enforcement of dynamic intent policies, leveraging synthetic data generation for training; whereas traditional LLM grounding systems apply static rule-based constraints, which do not evolve dynamically based on organizational security requirements. (5) Selective LLM Invocation versus Continuous External Querying: the system of some embodiments only invokes an LLM if an ML classifier detects a suspicious user query, optimizing latency and cost; in contrast, some conventional grounding systems invoke external computational sources for each and every user query, leading to higher computational overhead and increased latency and cost. (6) Synthetic Data Augmentation for Robust Intent Detection versus Direct Query Matching: the system of some embodiments generates variations or permutations of policy-violating prompts or queries, using RAG and adversarial augmentation techniques, and by taking into account actual Organizational Context as part of (or as input for) the Augmentation/Permutations process; whereas traditional systems, at most, match queries directly against external data repositories without augmenting training datasets. (7) Multi-Language and Code-Based Augmentation versus Standardized Query Execution: the system of some embodiments includes translation augmentation, mixed-language prompts, and code-based error simulation to detect intent circumvention attempts; whereas conventional grounding systems standardize and execute user queries without simulating potential adversarial modifications. (8) Feedback-Driven Adaptive Re-Training or Fine-Tuning, versus Static Verification Models: the system of some embodiments incorporates a continuous feedback loop where managers or security analysts or compliance reviewers can validate alerts and provide feedback, refining ML models and LLM detectors; whereas some traditional grounding methods do not continuously re-train or fine-tune based on user feedback, limiting adaptability to evolving threats and failing to learn from “false positive” erroneous alerts. (9) Multi-Turn Conversational Detection versus Single-Prompt Evaluation: the system of some embodiments detects and evaluates user intent by analyzing multi-turn conversations, identifying gradual data exfiltration attempts over multiple queries; whereas some conventional grounding systems, at most, assess each query independently, without correlating previous interactions for cross-query intent estimation. (10) LLM Fine-Tuned for Intent Detection versus Generalized Knowledge Models: the system of some embodiments fine-tunes LLMs for specific categories of policy violations (e.g., financial data, cybersecurity risks, confidential plans, HR data), thereby enhancing accuracy; whereas some traditional grounding systems rely on a general-purpose LLM that lacks specialized intent classification capabilities. (11) Adaptive Access Control Enforcement versus Passive Response Validation: some embodiments can be configured to dynamically modify, block, quarantine, or delay responses of the AI-based assistant tool based on risk assessment; whereas traditional grounding systems, at most, validate responses against reference data but do not enforce adaptive security measures such as decoy responses or query modification.

Some embodiments may generate the following innovative or non-obvious outputs or results. (1) Context-Aware Query Modification Suggestions, as the system may be configured to dynamically rewrite user queries that violate access policies, providing structured reformulations that adhere to security rules; instead of outright rejection, users may receive alternative phrasing that retrieves permissible information, maintaining workflow continuity while ensuring compliance with role-based data restrictions, reducing frustration and preventing repeated unauthorized access attempts. (2) Latent Insider Threat Discovery Reports, as by analyzing long-term AI interaction patterns, the system can be configured to identify gradual behavioral shifts indicative of insider threats; it generates detailed reports flagging employees whose queries evolve towards unauthorized data retrieval, helping security teams detect emerging risks before policy violations occur, mitigating potential data leaks through early intervention. (3) Deceptive Data Access Attempt Logs, as when users attempt to extract sensitive information using ambiguous or deceptive phrasing, the system logs these attempts with contextual explanations; security analysts receive enriched forensic reports showing query reformulations, intent assessments, and policy violation likelihood scores, enabling deeper investigation into whether the user is engaged in unauthorized intelligence gathering. (4) Multi-Layered Security Violation Risk Scores, as each flagged query is optionally assigned a composite risk score based on semantic similarity to known violations, organizational role context, historical behavior, and inferred malicious intent; the multi-layered scores prioritize alerts, allowing security personnel to focus on high-risk cases while reducing false positives, optimizing security workload distribution and operational efficiency. (5) Synthetic Data-Driven Policy Improvement Metrics, as the system can be configured to continuously generate synthetic adversarial queries to test its own security mechanisms; it produces detailed metrics on which types of reworded prompts successfully bypass security layers, providing administrators with actionable insights for improving policy configurations, classifier retraining, and response mechanisms to better detect evolving circumvention strategies. (6) Time-Sensitive Anomaly Reports on High-Risk Queries; for example, queries referencing financial reports, corporate transactions, or confidential projects can be flagged by the system with real-time contextual analysis; if unusual patterns emerge, such as heightened activity near earnings release dates or during restructuring events, the system generates alerts on potential opportunistic data access attempts, preventing unauthorized retrieval of market-sensitive or legally restricted information. (7) AI Interaction Integrity and Compliance Validation Reports, as the system generates real-time compliance validation logs for all AI-assisted interactions; the system ensures that each user query and response align with enterprise security frameworks and regulatory policies, producing audit-ready records that support compliance with relevant regulatory requirements (e.g., GDPR, HIPAA, SOC 2, or other data governance standards or regulations). (8) Cross-Domain Security Breach Indicators, as by correlating AI-assisted queries across different business units, the system can identify coordinated multi-user access attempts designed to extract fragmented pieces of restricted data; it can generate alerts when detected activity suggests a distributed breach strategy, where multiple employees request small portions of confidential information to avoid triggering single-user security mechanisms. (9) Decoy Data Interaction Analytics, as adversarial queries can trigger synthetic decoy responses, and the system can track how users react to misleading or vague information; if a user continues querying despite receiving plausible but incorrect responses, this behavioral pattern helps classify intent, determining whether the individual is engaged in unauthorized data gathering or merely testing system boundaries. (10) Enterprise-Wide AI Query Access Trend Reports, as the system can be configured to compile trend analyses on AI-based queries across an organization, identifying shifts in how employees interact with AI assistants; it detects whether certain departments or Organization Units or groups or peer-groups are increasingly requesting sensitive information, providing executive leadership with strategic insights into emerging operational security risks before they escalate into full-scale breaches. (11) Unusual Peer-Group Query Pattern Detection Logs, as when employees query AI systems about topics that are highly unusual for their department, job title, or peer group, the system can flag these anomalies; it generates logs that compare historical access patterns to current requests, allowing security teams to detect unusual deviations that could indicate compromised accounts or unauthorized knowledge discovery attempts. (12) Automated Query Categorization and Compliance Tagging, as every AI-generated response can be classified or tagged with compliance tags indicating whether it aligns with data governance policies; sensitive responses receive access-level categorization labels, ensuring that they can be systematically audited, redacted, or reviewed for policy adherence, streamlining enterprise security enforcement across AI-generated content streams.

Some embodiments may solve, prevent, cure and/or mitigate the following problems or disadvantages, or some of them. (1) Unintentional Insider Data Leaks, as employees may inadvertently request and retrieve sensitive data without realizing it violates company policies; the system mitigates this by preemptively analyzing intent, blocking unauthorized queries, and providing permissible reformulations, ensuring that employees only access information aligned with their job roles while preventing accidental leaks of confidential data. (2) Data Exfiltration via AI-Assisted Queries, as malicious actors can exploit AI-driven enterprise assistants to extract sensitive corporate information by phrasing requests strategically; the system prevents or stops this by employing multi-tiered analysis, detecting unauthorized queries before AI responses are generated, and enforcing security protocols that block or obfuscate information retrieval attempts designed for data exfiltration. (3) Policy Evasion via Query Rewording, as some users may attempt to bypass access restrictions by rephrasing queries or submitting indirect prompts that infer restricted information; the system identifies semantic rewording, paraphrasing, and linguistic inversions that maintain the same intent, ensuring that unauthorized access attempts are consistently detected, regardless of variations in query formulation. (4) Slow and Costly LLM-Based Access Control, as using only or mainly or dominantly an LLM for intent classification on every query can be computationally expensive and can introduce unacceptable performance delays; the system solves this by employing a multi-tiered approach, using a lightweight machine learning classifier for rapid pre-filtering and invoking an LLM only when necessary, optimizing both speed and cost efficiency. (5) Difficulty in Defining Granular AI Query Policies, as many enterprises struggle to manually define, enforce, and update AI-access policies at scale; the system automates this process by analyzing historical query patterns, generating intent-based policies, and dynamically refining security rules based on real-world usage, reducing administrative burdens while ensuring accurate and adaptive policy enforcement. (6) Inconsistent Access Control Across Departments, as traditional role-based access controls may not align with the complexity of real-world AI interactions, leading to inconsistencies where some employees receive unauthorized information while others are blocked arbitrarily; the system mitigates this by applying dynamic, context-sensitive enforcement that considers organizational hierarchies, peer groups, and real-time access contexts. (7) Lack of AI Query Auditing and Compliance, as some enterprises that utilize AI assistants often lack detailed logs of who accessed what information and why; the system provides structured auditing, logging every AI interaction, intent classification result, and policy enforcement decision; and this can assist with compliance with regulatory frameworks such as GDPR, SOC 2, and HIPAA while supporting forensic investigations. (8) Security Gaps in AI-Powered Customer Support or HR Systems, as some AI-driven enterprise tools that are used for HR, customer service, or internal assistance can be manipulated to disclose sensitive employee or client information; the system prevents or mitigates this by embedding security policies directly into AI query pipelines, ensuring that unauthorized queries are blocked before AI-generated responses reveal restricted details. (9) Coordinated Data Extraction Attempts, as a single user may be blocked from accessing certain information, but multiple employees working together might extract data in fragments; the system can be configured to detect cross-user collusion by correlating query patterns across departments or groups or Organizational Units, identifying when multiple individuals attempt to reconstruct restricted information through distributed access requests. (10) Lack of Protection Against Multilingual or Code-Mixed Queries, as some employees or adversaries may submit unauthorized queries in multiple languages or mixed linguistic formats to evade detection; the system can solve or prevent this by incorporating multilingual and code-switching detection, ensuring that policy enforcement mechanisms remain effective regardless of the language or phrasing used in AI queries. (11) Failure to Recognize Incremental Information Extraction, as some users attempt to gather sensitive data through multi-turn conversations, extracting small pieces of information over time; the system reconstructs entire conversational contexts, detecting when sequential queries build towards unauthorized knowledge discovery, preventing stepwise exfiltration tactics designed to circumvent single-query security restrictions. (12) Excessive False Positives in Query Blocking, as some traditional security mechanisms may block legitimate AI queries, frustrating employees and disrupting workflows; the system solves this by refining detection precision through adaptive learning, contextual query classification, and administrator feedback loops, ensuring that only truly unauthorized attempts are blocked while allowing policy-compliant AI interactions to proceed smoothly. (13) Lack of Real-Time Threat Detection in AI Interactions, as some conventional AI-related security tools only analyze access attempts after they occur; the system introduces real-time threat detection, proactively evaluating AI queries before responses are generated; and this can prevent sensitive information from ever being exposed, eliminating reliance on reactive mitigation strategies that attempt to contain breaches after they happen. (14) Static and Outdated Intent Classification Models, as manually defined security models often fail to adapt to evolving access patterns and adversarial query techniques; the system continuously retrains its classifiers using synthetic data, adversarial testing, and real-time user feedback, ensuring that intent detection models remain updated, resilient, and capable of detecting emerging unauthorized access strategies.

Some embodiments may provide a method comprising: receiving, by a query intake processor, a user-submitted query directed to an AI-based system; preprocessing the received query by applying tokenization, normalization, and metadata extraction to generate a structured representation of the query; retrieving, by a context retrieval engine, organizational metadata corresponding to the querying user, including role-based access attributes, hierarchical relationships, and historical query activity; embedding, by a query embedding transformer, the structured representation of the query into a high-dimensional vector space for rapid similarity comparison; classifying, by a machine learning classifier, the embedded query based on predefined access control policies to determine whether the query is permissible, ambiguous, or potentially unauthorized; detecting, by an adversarial query detection module, linguistic manipulations, paraphrased formulations, or syntactic rewordings designed to bypass security enforcement; retrieving, by an organizational context database, relevant security policies, role-based access constraints, and prior violation records associated with the querying user; determining, by a policy violation repository, whether the query exhibits characteristics similar to historical security breaches, unauthorized data access attempts, or restricted intent patterns; executing, by a multi-modal query interpreter, an additional validation step for non-textual inputs, including voice commands, image-based queries, and structured data requests; performing, by an LLM intent verification module, a secondary semantic evaluation of flagged queries to refine intent classification and reduce false positives; analyzing, by a behavioral anomaly detector, deviations from established query patterns to identify long-term shifts in user access behaviors that indicate potential insider threats; generating, by a multi-layered security violation risk scoring module, a composite risk score for the query based on contextual relevance, access history, and inferred malicious intent; triggering, by a security alert generation module, an automated notification when a query is determined to be unauthorized or high-risk, providing contextual details to security personnel; modifying, by a query rewriting engine, the original user-submitted query into a permissible alternative if the initial query is deemed unauthorized but reformulation is possible; enforcing, by a policy enforcement logic engine, real-time access control decisions, including query rejection, delayed execution, or additional authentication requirements; updating, by a feedback and adaptive learning interface, classification models based on administrator feedback, security analyst corrections, and user-provided justifications; augmenting, by a synthetic data generator, the training dataset with adversarial queries, linguistic distortions, and obfuscated access attempts to improve future detection accuracy; refining, by an automated policy tuning module, access control thresholds dynamically to account for evolving enterprise security requirements and newly detected circumvention techniques; logging, by an AI query auditing system, all processed queries, security decisions, and enforcement actions to support regulatory compliance, forensic investigations, and enterprise governance; storing, by a security response escalation manager, flagged queries and policy violation records in a structured repository for historical analysis, refinement of security policies, and risk mitigation planning.

Some embodiments may provide a method comprising: receiving, by an AI interaction monitoring system, a user query directed at an enterprise AI assistant; extracting, by a linguistic analysis module, query components including key terms, access intent indicators, and embedded metadata; retrieving, by an enterprise security context engine, organizational access control data including role-based permissions, team affiliations, and hierarchical authority; vectorizing, by a semantic embedding module, the extracted query features into a high-dimensional representation for real-time comparison; applying, by a machine learning intent classifier, initial categorization of the query to determine if it aligns with known security policies; referencing, by an organizational policy retrieval unit, stored access control rules and prior flagged query records to assess compliance; detecting, by an adversarial query analysis system, attempts to rephrase, mislead, or circumvent predefined security restrictions through linguistic variations; analyzing, by a contextual anomaly detection engine, whether the query deviates from the normal behavioral patterns of the querying user; applying, by a cross-user query correlation module, a comparative analysis to identify coordinated data extraction attempts involving multiple individuals; escalating, by a tiered intent validation mechanism, high-risk queries to a secondary classification model utilizing advanced natural language processing; performing, by a knowledge graph assessment module, an inference check to determine whether the requested information can be indirectly derived from prior AI responses; calculating, by a weighted security risk assessment module, a threat probability score based on query intent, user history, and external access conditions; enforcing, by an adaptive access control mechanism, a decision to allow, block, or modify the query based on enterprise-defined security protocols; rewriting, by an intent-preserving query transformation engine, non-compliant queries into permissible alternatives that maintain workflow continuity without violating access restrictions; triggering, by an automated alert system, a notification to security teams when high-risk or unauthorized queries are detected; storing, by a compliance logging module, an immutable record of the query, the associated security decision, and all applied enforcement actions; updating, by a continuous feedback learning system, machine learning models based on administrator interventions, security responses, and newly detected circumvention attempts; generating, by an adversarial training data synthesis module, simulated unauthorized queries to refine and improve AI security detection accuracy; synchronizing, by an enterprise-wide security enforcement module, detected access violations across multiple AI interfaces, ensuring uniform compliance enforcement across all enterprise AI interactions.

Some embodiments may provide a method comprising: intercepting, by an AI query processing gateway, all user-generated prompts directed at an enterprise AI system; decomposing, by a syntax and semantics analysis engine, the query into structured linguistic elements and identifying potentially sensitive data requests; referencing, by an organizational identity context retriever, stored employee role classifications, departmental access rights, and peer-group interaction patterns; embedding, by a deep contextual encoding unit, the query representation into a structured model for rapid security assessment; classifying, by an intent-driven risk assessment model, the query against predefined security policy categories; scanning, by a policy enforcement knowledge base, historical security rule violations and similar flagged access attempts; identifying, by a linguistic evasion detection system, potential query modifications intended to circumvent security rules through phrasing alterations; cross-referencing, by a federated AI compliance network, the query intent with prior access attempts across different organizational platforms; determining, by a peer-group behavior monitoring module, if the query aligns with normal operational patterns for the querying user's team; analyzing, by a context-driven AI access prediction engine, whether the query fits within the expected workflow for the user's role; escalating, by an adaptive security verification module, high-risk queries for additional validation by a large language model; processing, by a dynamic intent inference system, subtle variations in word usage to detect indirect or hidden data extraction attempts; scoring, by a security violation probability engine, the risk level associated with the query and the potential for unauthorized data access; executing, by an automated access enforcement module, a response action such as blocking, modifying, delaying, or flagging the query for review; rewriting, by an AI-generated policy-compliant reformulation unit, non-permissible queries into alternative versions that align with security policies; alerting, by an enterprise incident notification system, security administrators of repeated unauthorized query attempts or suspicious data access patterns; logging, by an AI forensic auditing framework, all AI interactions, access attempts, and security policy violations for compliance tracking; augmenting, by a synthetic adversarial query generator, the training dataset with additional unauthorized query simulations to improve detection capabilities; adapting, by a security policy self-learning module, access control models based on real-time feedback and administrator corrections; distributing, by a cross-platform AI governance integrator, updated access policies across multiple enterprise AI environments to maintain consistent security enforcement.

Some embodiments may provide a method comprising: receiving, by an AI query processing system, a user-submitted request and extracting associated metadata, including organizational identity, role, and contextual attributes; retrieving, by an enterprise policy engine, predefined security rules and access control restrictions corresponding to the querying user's role, department, and hierarchical position; embedding, by a semantic transformation module, the structured query into a vectorized representation for comparison against historical violations and known unauthorized access attempts; classifying, by a machine learning intent detection model, the query's inferred purpose, analyzing deviations from normal behavior, and identifying unauthorized data retrieval attempts; executing, by an adaptive security enforcement mechanism, an access control decision including query blocking, modification, delay, or escalation based on detected security risk factors; storing, by a compliance auditing system, a structured record of the query, classification decision, enforcement action, and security context for future analysis.

Some embodiments may provide a method comprising: intercepting, by an AI security gateway, a user query before execution, parsing its structural components and extracting access intent indicators; retrieving, by a federated authentication validator, identity verification details, role-based entitlements, and previous AI query interactions associated with the requesting user; embedding, by a query normalization module, the parsed input into a contextual representation mapped against enterprise knowledge graphs and hierarchical role-based access controls; analyzing, by an adversarial query detection system, whether the query is an attempt to circumvent existing security restrictions through phrasing modifications or manipulation; executing, by a security compliance engine, a policy enforcement decision based on an enterprise-defined response matrix, including query rejection, access limitation, or user verification; logging, by an AI forensic tracking system, all detected violations, enforcement actions, and access attempts for security auditing, compliance tracking, and governance analytics.

Some embodiments may provide a method comprising: capturing, by an AI interaction monitoring module, a user-submitted query directed to an enterprise AI system and extracting its linguistic structure; retrieving, by an enterprise access control manager, predefined data access rules, historical access logs, and compliance regulations associated with the querying user's profile; transforming, by a contextual embedding generator, the query into a machine-readable vector representation for real-time classification and similarity-based policy comparison; evaluating, by a risk-scoring engine, the security implications of the query, assessing probability scores for unauthorized access intent or policy violation; executing, by an AI security enforcer, a control decision to allow, block, modify, or escalate the query to an administrative reviewer for manual validation; storing, by a regulatory compliance tracker, all AI-generated access requests, security assessments, and enforcement decisions for audit logging and enterprise-wide risk mitigation.

Some embodiments may provide a method comprising: receiving, by a real-time AI security processor or controller or tracking unit, a user request submitted through an enterprise AI assistant or automated decision-making system; retrieving, by an identity management database, organizational role definitions, access entitlements, and hierarchical relationships linked to the querying user's profile; analyzing, by a contextual AI access filter, the semantic structure of the query and detecting anomalies, including query structure manipulations or adversarial phrasing; applying, by a multi-tiered machine learning classifier, probabilistic assessments to determine whether the query violates enterprise security policies or compliance regulations; executing, by an intent-based enforcement engine, an automated response including query blocking, modification, throttling, or security challenge issuance for verification purposes; storing, by an AI compliance archive, query logs, enforcement decisions, and policy validation records for future forensic analysis and enterprise security improvements.

Some embodiments may provide a method comprising: capturing, by an AI query monitoring system, every incoming user-submitted request and performing structural parsing to extract linguistic and contextual elements; retrieving, by an enterprise security rules engine, predefined role-based access restrictions, compliance parameters, and previously flagged query violation patterns; embedding, by a dynamic query transformation module, the extracted query into a high-dimensional security context representation for intelligent classification and intent analysis; identifying, by an unauthorized access detector, whether the query is part of a coordinated attempt to extract restricted enterprise data through indirect means; executing, by a risk-adaptive enforcement mechanism, a real-time access decision including immediate blocking, query rewriting, additional authentication, or administrator escalation; logging, by a compliance risk reporting system, all security-enforced AI interactions, detected policy violations, and system-wide security response analytics.

Some embodiments may provide a method comprising: receiving, by a real-time AI governance platform, a user-submitted natural language query intended for execution by an enterprise AI assistant; retrieving, by a federated access control system, predefined security constraints, prior access logs, and user-specific entitlements associated with the request; analyzing, by a deep-learning-driven classification model, the extracted query to determine security risk scores and potential policy violations; cross-referencing, by a historical query intelligence system, prior access attempts by the same user and detecting incremental knowledge-extraction patterns; executing, by a policy-aware AI enforcer, an automated action including query rejection, user verification, or partial-response modification to ensure compliance; storing, by an enterprise-wide risk analytics system, all enforced access control decisions, AI interactions, and detected security anomalies for forensic review.

Some embodiments may provide a method comprising: capturing, by an AI query security gateway, all incoming AI-generated user requests and parsing them into structured and unstructured contextual components; retrieving, by an enterprise security knowledge base, stored access restrictions, compliance policies, and predefined classifications for sensitive information queries; embedding, by a context-driven AI analysis module, query data into a security-enriched knowledge representation framework for real-time classification; assessing, by a multi-layered risk prediction model, whether the request aligns with permitted access conditions or suggests unauthorized intent; executing, by an AI-based security enforcement system, a decision to allow, restrict, modify, or escalate the request based on security rules; logging, by an enterprise compliance reporting engine, query metadata, classification outcomes, and all applied security enforcement actions.

Some embodiments may provide a method comprising: receiving, by an AI-driven access monitoring engine, a user-submitted natural language query directed at an enterprise AI-powered data system; retrieving, by a compliance-driven identity verification system, organizational access policies, hierarchical user entitlements, and stored access logs; analyzing, by a machine learning-based anomaly detection model, query structure for adversarial intent, manipulation, or unauthorized access attempts; classifying, by an intent-driven AI policy enforcement framework, the query's security risk level and probability of violating corporate access regulations; executing, by a dynamic AI security control mechanism, a real-time action including request denial, security challenge initiation, or automated escalation; storing, by an enterprise audit tracking system, all AI-query-related risk assessments, security actions, and compliance enforcement events for forensic evaluation.

Some embodiments may provide a method comprising: collecting, by an organizational context (OC) retrieval engine, structured and unstructured enterprise data including user roles, access permissions, historical interactions, and hierarchical relationships to establish a dynamic security-aware organizational knowledge base; receiving, by a real-time AI monitoring system, an incoming user-submitted query directed at an enterprise AI assistant and extracting linguistic structure, metadata, and contextual indicators to determine potential access-related risk factors; generating, by a query augmentation module, multiple permutations of the original query using adversarial techniques, linguistic variations, and syntactic transformations to simulate potential evasion attempts and improve robustness of security classification models; classifying, by a machine learning intent detection model, the original user query and its generated permutations against predefined access policies to determine security risk levels, unauthorized intent, or potential circumvention of enterprise compliance controls; determining, by a risk-based escalation mechanism, whether the classified query exhibits characteristics of unauthorized access attempts, and if detected, forwarding the original query for deeper semantic interpretation using a large language model (LLM); analyzing, by an LLM-driven contextual reasoning engine, the flagged user query by incorporating historical organizational context, entity relationships, and compliance parameters to refine intent classification and reduce false positives in security policy enforcement.

In some embodiments, the method comprises: updating the organizational context database continuously by integrating newly acquired identity attributes, team structures, access logs, and security policy changes to ensure real-time adaptation to evolving enterprise conditions.

In some embodiments, the method comprises: applying natural language processing techniques to preprocess the user query, extracting named entities, syntax patterns, and semantic relationships to enhance classification accuracy before applying machine learning models.

In some embodiments, the organizational context retrieval engine accesses multiple enterprise data sources, including identity providers, project management platforms, authentication logs, and internal knowledge bases, to construct a comprehensive and real-time security framework.

In some embodiments, the method comprises: applying vector embeddings to transform the user query and its permutations into high-dimensional representations, enabling similarity-based comparison against previously classified security violations and access attempts.

In some embodiments, the method comprises: generating permutations to user-provided queries, by simulating typographical errors, paraphrased formulations, code-switching patterns, and multilingual variations to evaluate whether policy evasion techniques are being used in AI-assisted interactions.

In some embodiments, the method comprises: detecting anomalous access behavior by cross-referencing the incoming query with historical user activity, identifying deviations from expected patterns that indicate unauthorized intent or suspicious data retrieval attempts.

In some embodiments, the method comprises: classifying the user query and permutations by assigning probability scores to each variation, using probabilistic risk models to determine the likelihood of unauthorized access attempts.

In some embodiments, the method comprises: generating a dynamic risk report summarizing the classified query's intent, organizational context, prior violations, and system-enforced decisions for compliance tracking and security auditing.

In some embodiments, the method comprises: invoking a machine learning model that applies a hierarchical classification structure, distinguishing between benign queries, low-risk deviations, and high-risk unauthorized access attempts based on predefined enterprise security rules.

In some embodiments, the method comprises: training the ML classifier using a dataset augmented with adversarial queries, synthetic unauthorized attempts, and real-world access violations to improve detection accuracy.

In some embodiments, the method comprises: incorporating user feedback into the classification process, allowing administrators to review flagged queries, correct false positives, and refine access policies dynamically.

In some embodiments, the method comprises: determining whether the query is risky by comparing query structure against a repository of known adversarial prompts, previously flagged security threats, and recorded unauthorized access attempts.

In some embodiments, the method comprises: applying a secondary review process for flagged queries by escalating them to an administrator before invoking the LLM-based semantic evaluation module.

In some embodiments, the method comprises: invoking an LLM-driven contextual reasoning engine that cross-references historical AI query logs to detect multi-turn interactions that may indicate incremental information extraction techniques.

In some embodiments, the method comprises: invoking an LLM that is fine-tuned using domain-specific security policies, corporate compliance rules, and enterprise access control conditions to improve its ability to detect policy violations.

In some embodiments, the method comprises: logging all AI-assisted query interactions, classification results, and enforcement actions to ensure compliance with regulatory standards such as GDPR, SOC 2, or HIPAA.

In some embodiments, the method comprises: configuring the organizational context retrieval engine to generate and to update a hierarchical knowledge graph of employees, teams, and enterprise resources to enhance query intent classification.

In some embodiments, the method comprises: introducing artificial query delay mechanisms for flagged interactions, preventing rapid sequential access attempts that could indicate automated data scraping or bulk extraction.

In some embodiments, the method comprises: modifying flagged queries before invoking the LLM, by applying lexical obfuscation detection techniques to determine if query manipulation attempts exist.

In some embodiments, the method comprises: generating permutations to user queries by applying RAG techniques to create synthetically generated query variations based on learned adversarial patterns.

In some embodiments, the method comprises: configuring the risk-based escalation mechanism to apply a weighted decision framework that prioritizes LLM-based analysis for high-risk or contextually ambiguous queries.

In some embodiments, the method comprises: dynamically adjusting security thresholds for query classification based on evolving threat models, historical violations, and enterprise-specific risk parameters.

In some embodiments, the method comprises: invoking LLM-based analysis that incorporates temporal access context, and evaluating whether the query timing suggests unauthorized intent, such as requests for confidential financial data before earnings reports.

In some embodiments, the method comprises: applying sentiment analysis to detect potentially coercive or misleading AI interactions indicative of social engineering attempts.

In some embodiments, the method comprises: applying ML classification of user queries that incorporates federated learning methodologies to continuously adapt and refine detection models based on anonymized security incidents across multiple enterprises.

In some embodiments, the method comprises: automatically constructing an AI-generated policy compliance report that justifies security enforcement decisions for internal audits and governance oversight.

In some embodiments, the method comprises: detecting coordinated access attempts by identifying query similarities across multiple users, and flagging collusion-based security threats.

In some embodiments, the method comprises: logging AI interactions by assigning unique transaction identifiers to each query for traceability and forensic investigation purposes.

In some embodiments, the method comprises: modifying security policies dynamically and/or automatically based on insights derived from LLM-based analysis and flagged policy violations. For example, the system may autonomously observe that 80 percent of the team-members of the Marketing Department have queried the AI assistant in the past week about salaries of top executives; and in response, the system may automatically update the security policy or the intent-based policy to entirely block access to salaries to the entire Marketing Department, and/or to other/additional departments of the organization.

In some embodiments, the method comprises: classifying the user query by performing contextual keyword scoring that evaluates whether access attempts align with normal/legitimate/typical enterprise workflows.

In some embodiments, the method comprises: invoking the risk escalation mechanism to apply multi-stage query evaluation, progressively increasing security scrutiny based on accumulated policy violation scores.

In some embodiments, the method comprises: introducing an administrator approval workflow for AI interactions that involve high-risk access attempts or ambiguous queries.

In some embodiments, the method comprises: invoking the LLM-based analysis to generate structured explanations for flagged queries, enabling transparency in security enforcement and administrator oversight.

Some embodiments may optionally use a Feedback Loop Mechanism for adaptive security enhancement in AI-assisted intent detection systems. For example, a Feedback Loop Mechanism in this AI-driven security enforcement system ensures continuous refinement of query classification models, risk assessment frameworks, and policy adaptation by integrating human and automated feedback into an iterative learning process. This mechanism is useful for improving detection accuracy, reducing false positives, refining risk thresholds, and adapting to evolving organizational security landscapes. The feedback loop consists of structured data collection, contextual feedback storage, RAG integration, retraining and fine-tuning procedures, and automated policy adaptation.

Feedback Collection for Security Alerts: Feedback can be systematically collected whenever an AI-assisted query triggers a security alert, undergoes risk-based classification, or is escalated for further validation. The system incorporates multiple feedback input points to capture human intervention, policy enforcement decisions, and automated performance evaluations. These input points may include, for example: (a) Administrator Override Feedback, as security administrators can manually override AI-enforced decisions, marking alerts as false positives or confirming malicious intent; overrides may include feedback on whether the flagged query should have been allowed, blocked, or modified. (b) User Access Dispute Feedback, as end-users whose queries were blocked can submit structured dispute requests, explaining why they believe their query was erroneously classified as a security risk. (c) Compliance Officer Annotations or Tagging, as compliance teams can attach regulatory context to security alerts, adding metadata that links enforcement decisions to specific organizational policies or legal requirements. (d) Automated Security Audit Logs, as each AI classification event is logged with system-generated metrics, including confidence scores, anomaly detection outcomes, and prior violation references; and the audit logs can be used to generate implicit feedback by tracking patterns in decision errors (e.g., generating an insight that all user-queries that were blocked and that related to “salaries” were actually false positive errors). (e) Historical Validation via Cross-User Analysis, as the system can examine whether similar queries by different users have resulted in different enforcement decisions, identifying inconsistencies and potential model drift requiring adjustment.

Collected feedback can be categorized into structured and unstructured formats to enhance utility in different adaptation processes. Some possible types of collected feedback may include: (a) Binary Feedback, such as Allow/Block confirmations for administrator overrides, providing a clear signal for classification correctness. (b) Weighted Risk Adjustments, as administrators or security teams can adjust risk weightings on flagged queries, modifying how similar queries are scored in future evaluations. (c) Semantic Correction Data, as if a query was rewritten to comply with security policies, the system can store both the original and the corrected version for training models to recognize permissible reformulations. (d) Query Contextual Tags, as feedback can include tags specifying whether a query is related to financial data, HR records, intellectual property, or external client interactions. (e) Language-Specific Adjustments, as if a query was misclassified due to language ambiguity or translation issues, feedback can be provided or annotated with the correct language model interpretation. (f) Longitudinal Behavior Tracking, as multiple instances of similar security alerts can occur for the same user, and the feedback about such pattern can aggregate prior decisions to refine anomaly detection accuracy.

All the collected feedback can be structured within a Feedback Repository, which serves as a continuously updated knowledge base for refining AI-assisted intent detection models. In some embodiments, the feedback can be stored in one or more of the following: (a) Vectorized Query Embeddings, as queries and corresponding feedback are transformed into high-dimensional embeddings, allowing the system to retrieve similar past cases for comparison during live query evaluations. (b) Feedback-Linked Policy Graphs, as feedback data is integrated into an enterprise-wide security policy graph, mapping decision trends, user roles, and historical security incidents to adjust automated enforcement strategies dynamically. (c) Distributed Log-Based Feedback Storage, as the system can maintain a distributed ledger of security feedback to prevent loss of institutional knowledge and ensure policy consistency across geographically dispersed enterprise environments. (d) Versioned Model Adjustment Logs, as every AI classification model update influenced by feedback is versioned and tagged with the specific feedback data used, ensuring traceability and rollback capabilities.

The feedback can be utilized for RAG; and the collected feedback can significantly enhances RAG-based query evaluation, improving contextual query interpretation and security enforcement decisions. The integration process may optionally include: (a) Real-Time Retrieval of Historical Feedback; when a new user query is classified, the system searches for similar past queries in the feedback repository, retrieving administrator decisions, user disputes, and compliance tags to refine classification. (b) Context-Enriched Query Processing, as Feedback-derived contextual enhancements are dynamically injected into the RAG pipeline, refining AI-generated explanations and enforcement justifications to reduce false positives. (c) Dynamic Prompt Augmentation; when invoking an LLM for secondary intent validation, the system appends historical feedback-derived prompts to improve contextual understanding, enabling better judgment of ambiguous queries.

Feedback can also be utilized for Model Retraining. For example, the feedback can assist in optimizing the ML models by continuously refining classification boundaries and intent detection rules. The feedback-to-retraining pipeline may include: (a) Supervised Learning with Administrator Labels, as feedback-marked queries serve as labeled data for supervised learning, improving the accuracy of the machine learning classifier. (b) Adversarial Query Generation, as false positive feedback can be used to generate synthetic adversarial queries, improving robustness against policy evasion attempts. (c) Domain-Specific Model Tuning, such as, the feedback may indicate recurring misclassification in a specific domain (e.g., financial access queries), and thus a dedicated fine-tuning of the ML model can be performed using domain-adaptive learning. (d) Threshold Calibration for Risk Scoring, as aggregated feedback can influence risk score calibration, modifying how aggressively classification models escalate or block uncertain queries.

Optionally, the feedback can be used for LLM Fine-Tuning, beyond the above-mentioned ML adaptation. The feedback can refine LLM-based contextual reasoning by, for example: (a) Creating Fine-Tuning Data Sets, as feedback-labeled query pairs are converted into fine-tuning datasets that enhance the LLM's understanding of enterprise-specific security policies. (b) Generating LLM Refinement Prompts, as feedback-derived cases can be included in few-shot learning prompts, enabling the LLM to generalize improved security judgments from prior feedback data. (c) Reducing False Positives with Context Expansion, as the system can identify frequent false positive scenarios from feedback and expands the LLM's decision context using retrieval-augmented input embeddings.

Optionally, automated policy adjustment can be performed based on feedback; and such feedback can be used for adjusting enterprise security policies dynamically; for example, by: (a) Detecting Security Rule Gaps, as frequent administrator overrides indicate policy misalignment, triggering automated recommendations to update access control rules. (b) Identifying Redundant Restrictions, as numerous similar queries that are flagged as false positives, can trigger policy constraints recalibration to improve usability without weakening security. (c) Adaptive Enforcement Thresholds, as the system can adjust query sensitivity thresholds in response to feedback trends, ensuring optimal balance between strict security enforcement and operational efficiency.

The feedback loop may further enable continuous learning and security adaptation, and can establish a self-improving AI governance system that evolves with enterprise needs; for example, by: (a) Detecting Emerging Security Threats, as unusual feedback patterns (e.g., increased manual overrides for specific query categories) indicate evolving security risks, prompting proactive threat assessment. (b) Automated Experimentation and A/B Testing, as the system deploys parallel model variations, testing different security classification strategies based on real-time feedback signals. (c) Long-Term Policy Evolution, as historical feedback data informs long-term security governance strategies, ensuring policies remain adaptive to technological advancements and emerging cyber threats.

The Feedback Loop Mechanism can thus serve as a tool for continuous optimization, ensuring that intent detection, query classification, and security enforcement evolve dynamically. Through structured feedback collection, adaptive RAG integration, fine-tuning processes, and automated policy adjustments, the system maintains high detection accuracy, reduced false positives, and continuous security adaptation to protect enterprise AI-assisted interactions.

Some embodiments provide a computerized method, comprising: (a) receiving from a user a user-provided query that is directed to an Artificial Intelligence (AI) based assistant tool that is configured to answer user queries based on information extracted from one or more organizational databases of an organization; (b) feeding the user-provided query into a Machine Learning (ML) classification model, that is configured to classify the user-provided query as one of: (b1) a possibly-malicious query that possibly violates an organizational policy of the organization, or (b2) a non-malicious query that does not violate organizational policies; (c1) if the ML classification model classified the user-provided query as a non-malicious query, then: processing the user-provided query by the AI-based assistant tool, and providing output from the AI-based assistant tool to said user; (c2) conversely, if the ML classification model classified the user-provided query as a possibly-malicious query, then: feeding the user-provided query to a Large Language Model (LLM) based Intent Detector that performs LLM analysis of the user-provided query and of organizational context, and receiving from the LLM-based Intent Detector an LLM-generated output that indicates whether or not the user-provided query is malicious and violates one or more organizational policies.

In some embodiments, the LLM-based Intent Detector is not invoked towards all user queries that are provided by users to the AI-based assistant tool, but rather, the LLM-based Intent Detector is selectively invoked only towards user-provided queries that the ML classification model has already classified as being possibly-malicious.

In some embodiments, step (c2) comprises: feeding into the LLM-based Intent Detector, as organizational context, information describing patterns of authorized access to organizational resources by users of said organization; wherein the LLM-based Intent Detector utilizes, as additional context for LLM-based determination whether the user-provided query is malicious and violates organizational policies, said information describing patterns of authorized access to data by users of said organization.

In some embodiments, step (c2) comprises: feeding into the LLM-based Intent Detector, as organizational context, information describing peer-groups of team-members within said organization and information describing subordinate and managerial relationships within said organization; wherein the LLM-based Intent Detector utilizes, as additional context for LLM-based determination whether the user-provided query is malicious and violates organizational policies, said information describing peer-groups of team-members within said organization and information describing subordinate and managerial relationship within said organization.

In some embodiments, step (c2) comprises: feeding into the LLM-based Intent Detector, as organizational context, information about the user who submitted the user-provided query, comprising at least name of said user, email address of said user, and organizational role of said user; wherein the LLM-based Intent Detector utilizes, as additional context for LLM-based determination whether the user-provided query is malicious and violates organizational policies, said information about the user who submitted the user-provided query, comprising at least name of said user, email address of said user, and organizational role of said user.

In some embodiments, step (c2) comprises: feeding into the LLM-based Intent Detector, as organizational context, information about (i) access events in which various users in the organization have accessed various organizational resources, and (ii) content and metadata and file-names of organizational resources that were accessed in said access events; wherein the LLM-based Intent Detector utilizes, as additional context for LLM-based determination whether the user-provided query is malicious and violates organizational policies, said information about (i) access events in which various users in the organization have accessed various organizational resources, and (ii) content and metadata and file-names of organizational resources that were accessed in said access events.

In some embodiments, step (c2) comprises: feeding into the LLM-based Intent Detector, as additional context, information about previous queries that were posed by said user to said AI-based assistant tool; wherein the LLM-based Intent Detector is configured to take into account, as additional context for evaluating said user-provided query, the information about previous queries that were posed by said user to said AI-based assistant tool.

In some embodiments, step (c2) comprises: feeding into the LLM-based Intent Detector, as additional context, information about previous queries that were posed by said user to said AI-based assistant tool; wherein the LLM-based Intent Detector is configured to combine two or more user-provided queries, of said user, wherein each of said two or more user-provided queries by itself does not indicate malicious user intent, wherein LLM-based analysis of a combination of said two or more user-provided queries indicates malicious user intent.

In some embodiments, step (c2) comprises: feeding into the LLM-based Intent Detector, as organizational context, information about (i) access events in which various users in the organization have accessed various organizational resources, and (ii) content and metadata and file-names of organizational resources that were accessed in said access events; wherein the LLM-based Intent Detector utilizes, as additional context for LLM-based determination whether the user-provided query is malicious and violates organizational policies, said information about (i) access events in which various users in the organization have accessed various organizational resources, and (ii) content and metadata and file-names of organizational resources that were accessed in said access events.

In some embodiments, step (c2) comprises: automatically generating and automatically feeding into the LLM-based Intent Detector an engineered intent-detection prompt, that is created automatically by a prompt generation unit based on an organizational policy describing permissible or non-permissible user intents or user actions.

In some embodiments, the method comprises: automatically creating the ML classification model by an Automated ML Training Unit, based on a dataset that comprises at least: (i) examples of user queries or user intents that are permissible, (ii) examples of user queries or user intents that are non-permissible.

In some embodiments, the method comprises: automatically training said ML classification model on a dataset of synthetic data-items, that were generated by an Augmentation LLM Unit that was configured to automatically generate (i) a plurality of synthetic textual examples of user queries that are permissible, and (ii) a plurality of synthetic textual examples of user queries that are non-permissible.

In some embodiments, the method comprises: automatically training said ML classification model on a dataset of synthetic data-items, that were generated by a Permutations LLM Unit that was configured to automatically generate a plurality of synthetic permutations of textual user queries that are non-permissible and that contain one or more typographical error or syntax errors or grammar errors or spelling errors or word-ordering errors.

In some embodiments, the method comprises: automatically training said ML classification model on a dataset of synthetic data-items, that were generated by a Permutations LLM Unit that was configured to automatically generate a plurality of synthetic permutations of textual user queries that are non-permissible and wherein an example of a non-permissible user query is converted by the Permutations LLM Unit into a multiple-turn set of two or more user queries that together reflect a non-permissible query.

In some embodiments, the method comprises: automatically training said ML classification model on a dataset of synthetic data-items, that were generated by a Translation LLM Unit that was configured to automatically generate (i) a plurality of synthetic permutations of textual user queries that are non-permissible and that are in a natural language that is different from a natural language of the user-provided query, and (ii) plurality of synthetic permutations of user queries wherein each user query comprises a mixture of words from two or more natural languages in a same sentence.

In some embodiments, the method comprises: automatically generating a dataset of synthetic examples of non-permissible user queries, by a Synthetic Data Generation LLM, based on a User Intent Policy that indicates at least one of: (i) one or more textual examples of non-permissible user queries, (ii) one or more rules that indicate which type of queries should be regarded as non-permissible; automatically training said ML classification model on said dataset of synthetic non-permissible user queries that were generated automatically by the Synthetic Data Generation LLM.

In some embodiments, the method comprises: (d) performing a Feedback Loop by: (d1) sending a notification to a reviewing entity to alert about flagging of the user-provided query as having malicious intent, (d2) obtaining from said reviewing entity feedback indicating correctness or incorrectness of said flagging, (d3) utilizing said feedback of said reviewing entity for at least one of: (I) re-training the ML classification model, (II) fine-tuning one or more LLM units that are utilized by said computerized method, (III) providing said feedback as additional context information to one or more LLM units that are utilized by said computerized method.

In some embodiments, the computerized method is implemented as one of, or using one of: an integral module of said AI-based assistant tool, an extension module to said AI-based assistant tool, a pre-processing module that evaluates user queries prior to their processing by said AI-based assistant tool, a post-processing module that evaluates user queries subsequent to their processing by said AI-based assistant tool, a concurrent-processing or parallel processing module or parallel thread or parallel pipeline that evaluates user queries in parallel to their processing by said AI-based assistant tool, a component that is connected in a pipeline of said AI-based assistant tool, a component of a data-lake or a data-silo of said organization; a component connected to a data-lake or a data-silo of said organization.

Some embodiments provide a system comprising: one or more hardware processors, that are configured to execute code, and that are operably associated with one or more memory units; wherein the one or more hardware processors are configured to perform a method as described.

Some embodiments provide a non-transitory storage medium having stored thereon instructions that, when executed by a machine, cause the machine to perform a method as described.

Although portions of the discussion herein relate, for demonstrative purposes, to wired links and/or wired communications, some embodiments of the present invention are not limited in this regard, and may include one or more wired or wireless links, may utilize one or more components of wireless communication, may utilize one or more methods or protocols of wireless communication, or the like. Some embodiments may utilize wired communication and/or wireless communication.

Some embodiments may be implemented by using hardware units, software units, processors, CPUs, DSPs, GPUs, integrated circuits (ICs), memory units, storage units, wireless communication modems or transmitters or receivers or transceivers, cellular transceivers, a power source, input units, output units, Operating System (OS), drivers, applications, and/or other suitable components.

Some embodiments may be integrated with or into, or can be implemented as an extension or add-on or plug-in, to a Data Security Platform (DSP), a Data Security Posture Management (DSPM) system, a Data Discovery and Classification system, a cloud-based Data Loss Prevention (DLP) system, a User and Entity Behavior Analytics (UEBA) system, a Managed Data Detection and Response (MDDR) system, a data storage and retrieval system, an AI-based or AI-driven information retrieval system that utilizes an AI-based tool or an AI-based chat-bot or an LLM or an LLM-based chat-bot to answer user queries based on a repository of documents and/or to provide to users retrieved documents (or document-portions, or document-segments, or document highlights, or document summaries) in response to user queries, a data security and analytics platform, a system for storing or managing a “data lake” or a “data silo” and for retrieving information therefrom, a local or on-premises repository of documents or data-items, a cloud-based or server-side or remote repository of documents or data-items, a set of virtual and/or physical drives and/or folders and/or files and/or documents that can be searched or queried or accessed via a search module or a query module or directly via a files browsing module, a Customer Relationship Management (CRM) system that has or that uses Information Retrieval (IR) components, a Supply Chain Management (SCM) system that has or that uses IR components, an Enterprise Resource Planning (ERP) system that has or that uses IR components, a group-messaging or team-based messaging platform that enables users to share information and to retrieve information or to query for information, and/or other platforms or systems that can benefit from having access to an accurate and up-to-date list that assigns organizational roles to organizational users.

Some embodiments may include, or may utilize, or may operate in conjunction with, local and/or co-located and/or remote and/or cloud-based servers or computers that are configured to run, or that implement, an Artificial Intelligence (AI) tool or unit or engine, or a unit or engine that utilize or that comprises a Neural Network (NN) or an Artificial NN (ANN) or a Convolutional NN (CNN) or a Recurrent NN (RNN), or a unit or engine that utilizes or the comprises a Machine Learning (ML) or a Deep Learning (DL) model or engine, or a unit or engine that is trained to identify or recognize or extract or deduce patterns from data or dataset(s) and/or to autonomously perform feature extraction and/or to generate prediction or estimations or decisions in a manner that is not based on deterministic pre-programmed prediction rules or decision rules or estimation rules, or a unit or engine or model that is trained or configured via supervised learning and/or self-supervised learning and/or unsupervised learning and/or reinforcement learning, or a unit or engine that implements or utilizes or comprises a Large Language Model (LLM) or a large Vision-and-Language Model (VLM) or a large Language-and-Vision Model (LVM) or a Large Multi-Modalities Model or a Large Multiple-Modalities Model (LMM or LMMM) such as OpenAI Chat-GPT or Microsoft Copilot or Anthropic Claude or Meta Llama or Google Gemini or Mistral AI or Grok xAI or a Vision-Language-Action (VLA) model (e.g., Google Gemini Robotics), or a unit or model that specializes in Natural Language Processing (NLP) tasks such as language processing generation and/or image processing and generation and/or document processing and generation and/or video processing and generation, or a unit or model or engine that comprise or utilize a set of Generative Pretrained Transformers (GPTs), or a unit or model that can be guided or instructed or queried via textual prompts and/or via prompt engineering, or a unit or model that utilizes tokens or tokenized information in order to generate or predict or provide one or more next tokens or subsequent tokens, or a unit or engine that utilizes embeddings or vectorized databases to represent information, or a unit or engine that perform enrichment/augmentation of information or enrichment/augmentation of context that is provided as input to such model by using Retrieval-Augmented Generation (RAG) or other augmentation/enrichment techniques, or a unit or engine that is configured to train or re-train or fine-tune a model or to modify weights and/or biases and/or parameters and/or coefficients of a model, or a unit or controller that controls or commands or provides prompts to one or more of the above-mentioned models that are arrange in parallel or in series or as a matrix or array or cascade, or a unit or engine that obtains or aggregates or combines outputs from two or more of such models or units.

Some embodiments may be implemented by using a special-purpose machine or a specific-purpose that is not a generic computer, or by using a non-generic computer or a non-general computer or machine. Such system or device may utilize or may comprise one or more units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented by using code or program code or machine-readable instructions or machine-readable code, which is stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such device to perform a method in accordance with the present invention.

Some embodiments may be utilized with a variety of devices or systems having a touch-screen or a touch-sensitive surface; for example, a smartphone, a cellular phone, a mobile phone, a smart-watch, a tablet, a handheld device, a portable electronic device, a portable gaming device, a portable audio/video player, an Augmented Reality (AR) or Virtual Reality (VR) or Mixed Reality (XR) device or headset or gear, a “kiosk” type device, a vending machine, an Automatic Teller Machine (ATM), a laptop computer, a desktop computer, a vehicular computer, a vehicular dashboard, a vehicular touch-screen, or the like.

The system(s) and/or device(s) of some embodiments may optionally comprise, or may be implemented by utilizing suitable hardware components and/or software components; for example, processors, processor cores, Central Processing Units (CPUs), Digital Signal Processors (DSPs), circuits, Integrated Circuits (ICs), controllers, memory units, registers, accumulators, storage units, input units (e.g., touch-screen, keyboard, keypad, stylus, mouse, touchpad, joystick, trackball, microphones), output units (e.g., screen, touch-screen, monitor, display unit, audio speakers), acoustic microphone(s) and/or sensor(s), optical microphone(s) and/or sensor(s), laser or laser-based microphone(s) and/or sensor(s), wired or wireless modems or transceivers or transmitters or receivers, GPS receiver or GPS element or other location-based or location-determining unit or system, network elements (e.g., routers, switches, hubs, antennas), and/or other suitable components and/or modules.

The system(s) and/or devices of some embodiments may optionally be implemented by utilizing co-located components, remote components or modules, “cloud computing” servers or devices or storage, client/server architecture, peer-to-peer architecture, distributed architecture, and/or other suitable architectures or system topologies or network topologies.

In accordance with some embodiments, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit, a Flash drive), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL), BASIC, Visual BASIC, MATLAB, Pascal, HTML, HTML5, CSS, Dart, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

Some embodiments of the present invention may perform steps or operations such as, for example, “determining”, “identifying”, “comparing”, “checking”, “querying”, “searching”, “matching”, and/or “analyzing”, by utilizing, for example: a pre-defined threshold value to which one or more parameter values may be compared; a comparison between (i) sensed or measured or calculated value(s), and (ii) pre-defined or dynamically-generated threshold value(s) and/or range values and/or upper limit value and/or lower limit value and/or maximum value and/or minimum value; a comparison or matching between sensed or measured or calculated data, and one or more values as stored in a look-up table or a legend table or a list of reference value(s) or a database of reference values or ranges; a comparison or matching or searching process which searches for matches and/or identical results and/or similar results and/or sufficiently-close results (e.g., within a pre-defined threshold level of similarity; such as, within 5 percent above or below a pre-defined threshold value), among multiple values or limits that are stored in a database or look-up table; utilization of one or more equations, formula, weighted formula, and/or other calculation in order to determine similarity or a match between or among parameters or values; utilization of comparator units, lookup tables, threshold values, conditions, conditioning logic, Boolean operator(s) and/or other suitable components and/or operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Repeated use of the phrase “in one embodiment” does not necessarily refer to the same embodiment, although it may. Repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may comprise, or may be implemented by using, an “app” or application which may be downloaded or obtained from an “app store” or “applications store”, for free or for a fee, or which may be pre-installed on a computing device or electronic device, or which may be transported to and/or installed on such computing device or electronic device.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may comprise any possible combinations, re-arrangements, assembly, re-assembly, or other utilization of some or all of the modules or functions or components that are described herein, even if they are discussed in different locations or different chapters of the above discussion, or even if they are shown across different drawings or multiple drawings.

While certain features of some embodiments have been illustrated and described herein, many modifications, substitutions, changes, and equivalents may occur to those skilled in the art. Accordingly, the claims are intended to cover all such modifications, substitutions, changes, and equivalents.

What is claimed is:

1. A computerized method, comprising:
(a) receiving from a user a user-provided query that is directed to an Artificial Intelligence (AI) based assistant tool that is configured to answer user queries based on information extracted from one or more organizational databases of an organization;
(b) feeding the user-provided query into a Machine Learning (ML) classification model, that is configured to classify the user-provided query as one of: (b1) a possibly-malicious query that possibly violates an organizational policy of the organization, or (b2) a non-malicious query that does not violate organizational policies;
(c1) if the ML classification model classified the user-provided query as a non-malicious query, then: processing the user-provided query by the AI-based assistant tool, and providing output from the AI-based assistant tool to said user;
(c2) conversely, if the ML classification model classified the user-provided query as a possibly-malicious query, then: feeding the user-provided query to a Large Language Model (LLM) based Intent Detector that performs LLM analysis of the user-provided query and of organizational context, and receiving from the LLM-based Intent Detector an LLM-generated output that indicates whether or not the user-provided query is malicious and violates one or more organizational policies.

2. The computerized method of claim 1,
wherein the LLM-based Intent Detector is not invoked towards all user queries that are provided by users to the AI-based assistant tool, but rather, the LLM-based Intent Detector is selectively invoked only towards user-provided queries that the ML classification model has already classified as being possibly-malicious.

3. The computerized method of claim 2, wherein step (c2) comprises:
feeding into the LLM-based Intent Detector, as organizational context, information describing patterns of authorized access to organizational resources by users of said organization;
wherein the LLM-based Intent Detector utilizes, as additional context for LLM-based determination whether the user-provided query is malicious and violates organizational policies, said information describing patterns of authorized access to data by users of said organization.

4. The computerized method of claim 3, wherein step (c2) comprises:
feeding into the LLM-based Intent Detector, as organizational context, information describing peer-groups of team-members within said organization and information describing subordinate and managerial relationships within said organization;
wherein the LLM-based Intent Detector utilizes, as additional context for LLM-based determination whether the user-provided query is malicious and violates organizational policies, said information describing peer-groups of team-members within said organization and information describing subordinate and managerial relationship within said organization.

5. The computerized method of claim 4, wherein step (c2) comprises:
feeding into the LLM-based Intent Detector, as organizational context, information about the user who submitted the user-provided query, comprising at least name of said user, email address of said user, and organizational role of said user;
wherein the LLM-based Intent Detector utilizes, as additional context for LLM-based determination whether the user-provided query is malicious and violates organizational policies, said information about the user who submitted the user-provided query, comprising at least name of said user, email address of said user, and organizational role of said user.

6. The computerized method of claim 5, wherein step (c2) comprises:
feeding into the LLM-based Intent Detector, as organizational context, information about (i) access events in which various users in the organization have accessed various organizational resources, and (ii) content and metadata and file-names of organizational resources that were accessed in said access events;
wherein the LLM-based Intent Detector utilizes, as additional context for LLM-based determination whether the user-provided query is malicious and violates organizational policies, said information about (i) access events in which various users in the organization have accessed various organizational resources, and (ii) content and metadata and file-names of organizational resources that were accessed in said access events.

7. The computerized method of claim 6, wherein step (c2) comprises:
feeding into the LLM-based Intent Detector, as additional context, information about previous queries that were posed by said user to said AI-based assistant tool;
wherein the LLM-based Intent Detector is configured to take into account, as additional context for evaluating said user-provided query, the information about previous queries that were posed by said user to said AI-based assistant tool.

8. The computerized method of claim 7, wherein step (c2) comprises:
feeding into the LLM-based Intent Detector, as additional context, information about previous queries that were posed by said user to said AI-based assistant tool;
wherein the LLM-based Intent Detector is configured to combine two or more user-provided queries, of said user, wherein each of said two or more user-provided queries by itself does not indicate malicious user intent, wherein LLM-based analysis of a combination of said two or more user-provided queries indicates malicious user intent.

9. The computerized method of claim 8, wherein step (c2) comprises:
feeding into the LLM-based Intent Detector, as organizational context, information about (i) access events in which various users in the organization have accessed various organizational resources, and (ii) content and metadata and file-names of organizational resources that were accessed in said access events;
wherein the LLM-based Intent Detector utilizes, as additional context for LLM-based determination whether the user-provided query is malicious and violates organizational policies, said information about (i) access events in which various users in the organization have accessed various organizational resources, and (ii) content and metadata and file-names of organizational resources that were accessed in said access events.

10. The computerized method of claim 9, wherein step (c2) comprises:
automatically generating and automatically feeding into the LLM-based Intent Detector an engineered intent-detection prompt, that is created automatically by a prompt generation unit based on an organizational policy describing permissible or non-permissible user intents or user actions.

11. The computerized method of claim 2, comprising:
automatically creating the ML classification model by an Automated ML Training Unit, based on a dataset that comprises at least: (i) examples of user queries or user intents that are permissible, (ii) examples of user queries or user intents that are non-permissible.

12. The computerized method of claim 11, comprising:
automatically training said ML classification model on a dataset of synthetic data-items, that were generated by an Augmentation LLM Unit that was configured to automatically generate (i) a plurality of synthetic textual examples of user queries that are permissible, and (ii) a plurality of synthetic textual examples of user queries that are non-permissible.

13. The computerized method of claim 12, comprising:
automatically training said ML classification model on a dataset of synthetic data-items, that were generated by a Permutations LLM Unit that was configured to automatically generate a plurality of synthetic permutations of textual user queries that are non-permissible and that contain one or more typographical error or syntax errors or grammar errors or spelling errors or word-ordering errors.

14. The computerized method of claim 13, comprising:
automatically training said ML classification model on a dataset of synthetic data-items, that were generated by a Permutations LLM Unit that was configured to automatically generate a plurality of synthetic permutations of textual user queries that are non-permissible and wherein an example of a non-permissible user query is converted by the Permutations LLM Unit into a multiple-turn set of two or more user queries that together reflect a non-permissible query.

15. The computerized method of claim 14, comprising:
automatically training said ML classification model on a dataset of synthetic data-items, that were generated by a Translation LLM Unit that was configured to automatically generate (i) a plurality of synthetic permutations of textual user queries that are non-permissible and that are in a natural language that is different from a natural language of the user-provided query, and (ii) plurality of synthetic permutations of user queries wherein each user query comprises a mixture of words from two or more natural languages in a same sentence.

16. The computerized method of claim 2, comprising:
automatically generating a dataset of synthetic examples of non-permissible user queries, by a Synthetic Data Generation LLM, based on a User Intent Policy that indicates at least one of: (i) one or more textual examples of non-permissible user queries, (ii) one or more rules that indicate which type of queries should be regarded as non-permissible;
automatically training said ML classification model on said dataset of synthetic non-permissible user queries that were generated automatically by the Synthetic Data Generation LLM.

17. The computerized method of claim 16, comprising:
(d) performing a Feedback Loop by
(d1) sending a notification to a reviewing entity to alert about flagging of the user-provided query as having malicious intent,
(d2) obtaining from said reviewing entity feedback indicating correctness or incorrectness of said flagging,
(d3) utilizing said feedback of said reviewing entity for at least one of: (I) re-training the ML classification model, (II) fine-tuning one or more LLM units that are utilized by said computerized method, (III) providing said feedback as additional context information to one or more LLM units that are utilized by said computerized method.

18. The computerized method of claim 2,
wherein the computerized method is implemented as one of:
an integral module of said AI-based assistant tool,
an extension module to said AI-based assistant tool,
a pre-processing module that evaluates user queries prior to their processing by said AI-based assistant tool,
a post-processing module that evaluates user queries subsequent to their processing by said AI-based assistant tool,
a concurrent-processing module that evaluates user queries in parallel to their processing by said AI-based assistant tool,
a component that is connected in a pipeline of said AI-based assistant tool,
a component of a data-lake or a data-silo of said organization,
a component connected to a data-lake or a data-silo of said organization.

19. A system comprising:
one or more hardware processors, that are configured to execute code,
and that are operably associated with one or more memory units;
wherein the one or more hardware processors are configured to perform a computerized process comprising:
(a) receiving from a user a user-provided query that is directed to an Artificial Intelligence (AI) based assistant tool that is configured to answer user queries based on information extracted from one or more organizational databases of an organization;
(b) feeding the user-provided query into a Machine Learning (ML) classification model, that is configured to classify the user-provided query as one of: (b1) a possibly-malicious query that possibly violates an organizational policy of the organization, or (b2) a non-malicious query that does not violate organizational policies;
(c1) if the ML classification model classified the user-provided query as a non-malicious query, then: processing the user-provided query by the AI-based assistant tool, and providing output from the AI-based assistant tool to said user;
(c2) conversely, if the ML classification model classified the user-provided query as a possibly-malicious query, then: feeding the user-provided query to a Large Language Model (LLM) based Intent Detector that performs LLM analysis of the user-provided query and of organizational context, and receiving from the LLM-based Intent Detector an LLM-generated output that indicates whether or not the user-provided query is malicious and violates one or more organizational policies.

20. A non-transitory storage medium having stored thereon instructions that, when executed by a machine, cause the machine to perform a computerized process comprising:
(a) receiving from a user a user-provided query that is directed to an Artificial Intelligence (AI) based assistant tool that is configured to answer user queries based on information extracted from one or more organizational databases of an organization;
(b) feeding the user-provided query into a Machine Learning (ML) classification model, that is configured to classify the user-provided query as one of: (b1) a possibly-malicious query that possibly violates an organizational policy of the organization, or (b2) a non-malicious query that does not violate organizational policies;
(c1) if the ML classification model classified the user-provided query as a non-malicious query, then: processing the user-provided query by the AI-based assistant tool, and providing output from the AI-based assistant tool to said user;
(c2) conversely, if the ML classification model classified the user-provided query as a possibly-malicious query, then: feeding the user-provided query to a Large Language Model (LLM) based Intent Detector that performs LLM analysis of the user-provided query and of organizational context, and receiving from the LLM-based Intent Detector an LLM-generated output that indicates whether or not the user-provided query is malicious and violates one or more organizational policies.
